(19) United States
(12) Patent Application Publication
(10) Pub. No.: US 2026/0290190 A1
(43) Pub. Date: Sep. 24, 2026

(54) SYSTEM

(71) Applicant: SoftBank Group Corp., Tokyo (JP)

(72) Inventor: Mari WATANABE, Tokyo (JP)

(73) Assignee: SoftBank Group Corp., Tokyo (JP)

(21) Appl. No.: 19/561,922

(22) Filed: Mar. 10, 2026

(30) Foreign Application Priority Data
Mar. 19, 2025 (JP) 2025-044990

(51) Int. Cl. G09B 7/04; G06F 40/40; G06N 3/0475; G06V 40/16; G09B 7/08; G10L 25/63

(52) U.S. Cl. CPC G09B 7/04; G06N 3/0475; G09B 7/08; G06F 40/40; G06V 40/174; G10L 25/63

(57) ABSTRACT

A system includes a processor that is configured to acquire past learning histories of a learner from a database and analyze a level of understanding of the learner by using a machine learning algorithm, input, to a generative AI model, a prompt for instructing the generative AI model to generate questions in accordance with the level of understanding of the learner, and evaluate answers of the learner and generate feedback by using the generative AI model.

### CROSS-REFERENCE TO RELATED APPLICATION

This application is based on and claims priority under 35 USC 119 from Japanese Patent Application No. 2025-044990 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional computer-assisted learning systems typically rely on static question banks and manually designed rules for adjusting question difficulty. In such systems, a processor often selects questions from a predetermined set based on simple metrics, such as the number of correct answers or elapsed time, without deeply analyzing an individual learner's understanding. As a result, questions may not be sufficiently tailored to the learner's actual comprehension level, leading to inefficient learning and reduced engagement. Furthermore, in many existing systems, the generation of explanations and feedback is either manual or template-based, which limits the richness, context-awareness, and adaptability of the feedback provided to the learner. In addition, the classification of learners into skill levels or groups is frequently performed using coarse, heuristic methods that do not effectively exploit the full structure of the learning data. There is therefore a need for a system that can automatically analyze a learner's understanding from past learning histories using machine learning algorithms, and then generate questions and feedback that are dynamically adapted to the learner. There is also a need for a system that can use clustering techniques to classify learners into multiple groups based on their levels of understanding and to generate optimal questions for each group. Moreover, there is a need for a system capable of providing real-time, generative feedback to learner answers, and presenting such feedback to an information processing apparatus in a way that enhances the learner's comprehension and shortens the feedback loop. The present invention has been made in view of these problems.

### SUMMARY

In order to solve at least part of the above problems, according to one aspect of the present invention, there is provided a system comprising a processor, wherein the processor is configured to acquire past learning histories of a learner from a database and analyze a level of understanding of the learner by using a machine learning algorithm, input, to a generative AI model, a prompt for instructing the generative AI model to generate questions in accordance with the level of understanding of the learner, and evaluate answers of the learner and generate feedback by using the generative AI model. By using the machine learning algorithm on the past learning histories, the processor can derive a more precise and dynamic representation of the learner's understanding than simple rule-based methods, thereby enabling the generative AI model to produce questions that are better matched to the learner's needs.

According to another aspect of the invention, the processor is configured to classify the level of understanding of the learner into a plurality of groups by using a clustering technique, and input, to the generative AI model, a prompt for instructing the generative AI model to generate questions optimal for each of the plurality of groups. By employing clustering techniques on learner data, the processor can identify latent groups of learners with similar understanding profiles and can tailor question generation at the group level, thereby improving scalability and consistency in adaptive learning content.

According to a further aspect of the invention, the processor is configured to input, to the generative AI model, a prompt for instructing the generative AI model to generate feedback in real time for the answers of the learner, and display the generated feedback on an information processing apparatus. By causing the generative AI model to generate feedback immediately after the learner submits an answer, the system can shorten the feedback cycle and present personalized, context-aware explanations or hints through the information processing apparatus. As a result, the system can provide adaptive question generation and real-time, generative feedback that collectively improve learning efficiency, learner engagement, and the overall quality of educational support.

The term “system” refers to a combination of hardware and software components including at least one processor and associated memory, storage, and communication interfaces configured to execute the processing described in the claims.

The term “processor” refers to any hardware device or combination of devices capable of executing instructions, including but not limited to a central processing unit (CPU), a graphics processing unit (GPU), a digital signal processor (DSP), or a dedicated accelerator, whether implemented as a single unit or a distributed set of units.

The term “learner” refers to a user who interacts with the system for the purpose of obtaining educational content, answering questions, and receiving feedback regarding one or more learning subjects.

The term “learning history” refers to data representing past learning activities of a learner, including, for example, question identifiers, timestamps, learner answers, correctness information, scores, accessed materials, and other records related to the learner's interactions with educational content.

The term “database” refers to any structured or semi-structured data storage system, including relational databases, NoSQL databases, key-value stores, or other persistent storage, that stores learning histories and other data used by the processor.

The term “machine learning algorithm” refers to an algorithm or model that learns patterns or parameters from data, such as supervised learning, unsupervised learning, reinforcement learning, or deep learning methods, and that is used by the processor to analyze the learner's level of understanding.

The term “level of understanding” refers to a quantitative or qualitative indication of how well a learner comprehends a particular topic or set of topics, which may be expressed as a score, probability, category, or other metric derived from the learner's learning history.

The term “generative AI model” refers to an artificial intelligence model, such as a large language model or other generative model, that is capable of generating natural language text or other content in response to given input prompts.

The term “prompt” refers to input data, typically comprising natural language text and optionally structured parameters, that is provided to the generative AI model to instruct the generative AI model to perform a specific generation task, such as generating questions or feedback.

The term “question” refers to an item of assessment or inquiry generated for the learner, including, for example, multiple-choice questions, free-text questions, coding tasks, or other problem statements intended to elicit a response from the learner.

The term “feedback” refers to information generated for the learner based on the learner's answer, including explanations, evaluations, hints, suggestions, corrections, or other guidance intended to improve the learner's understanding.

The term “clustering technique” refers to an unsupervised machine learning method that groups data points, including learner profiles or learning histories, into a plurality of clusters based on similarity metrics, without requiring labeled training data.

The term “group” refers to a cluster or category of learners or learner states that share similar levels or patterns of understanding, as determined by the clustering technique applied to learning histories or related data.

The term “optimal questions” refers to questions that are selected or generated such that they are suitable or advantageous for learners belonging to a particular group, in view of the learners' levels of understanding, learning goals, or pedagogical criteria.

The term “real time” refers to a processing mode in which the system generates and provides output, such as feedback, with a delay that is short enough to allow the learner to receive the output substantially immediately after submitting an answer, within an interactive session.

The term “information processing apparatus” refers to any electronic device capable of presenting output from the system to the learner and, optionally, receiving input from the learner, including but not limited to a personal computer, tablet, smartphone, or dedicated learning terminal.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

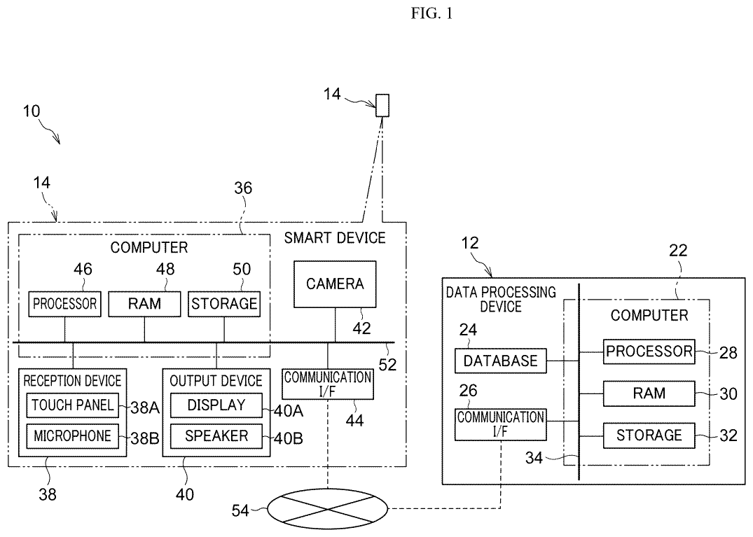

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

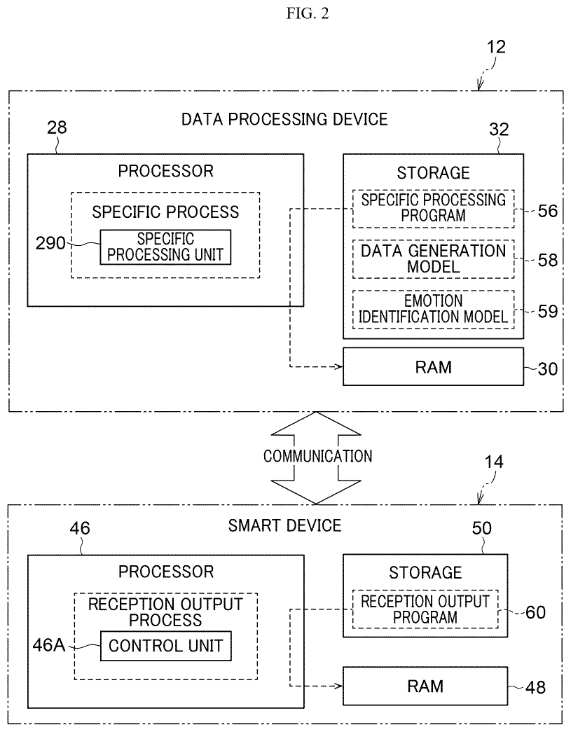

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented learning support systems typically deliver learning content and questions based on static difficulty settings or coarse rule-based logic that does not reflect a learner's current understanding level in a fine-grained manner. Even when such systems collect learning history data, the processing is often limited to simple score aggregation or threshold judgment, and does not exploit machine learning techniques to generate continuous, topic-wise understanding metrics. As a result, the server-side control logic is unable to dynamically adapt question selection, feedback timing, and content generation to the learner's evolving state, which leads to inefficiencies in the usage of computing resources and network bandwidth and provides a suboptimal user experience.

In addition, in many existing systems that incorporate automated content generation, a generative AI model is invoked in an ad hoc manner with manually crafted prompts. The prompts do not systematically encode structured parameters such as topic, subtopic, difficulty, response time, and historical correctness patterns computed by a server. This lack of systematic prompt construction prevents the generative AI model from fully leveraging the rich state information available on the server, causing redundant generation requests, inconsistent output quality, and unnecessary load on the computing infrastructure.

Furthermore, conventional architectures typically decouple answer evaluation and feedback generation from the core server logic, either by relegating evaluation to simple answer matching or by providing delayed, batch-processed feedback. Such approaches do not implement a closed feedback loop in which a server continuously updates a machine-learned understanding score, regenerates prompt sentences based on that score, and requests new, tailored questions and feedback from a generative AI model in real time. This results in high latency between learner actions and system responses, underutilization of historical data, and limited ability of the server to optimize learning flows over time.

Therefore, there is a need for a computer technology that improves the internal operation of the server in a learning support system by: (i) systematically transforming raw learning history into machine-learning-ready feature data; (ii) generating and updating numerical understanding scores on a per-topic basis; (iii) automatically constructing structured prompt sentences for a generative AI model based on such scores and other state data; and (iv) integrating real-time answer evaluation and feedback generation into a continuous, adaptive control loop. Such a technology would improve the efficiency, responsiveness, and scalability of the server-side processing pipeline, reduce redundant computation and network traffic, and enhance the technical quality and consistency of AI-generated educational content.

The specific processing by the specific processing unit 290 of the data processing device 12 in Example 1 is realized by the following means.

The present invention provides a server comprising a processor and a storage device, wherein the processor is configured to execute computer-implemented operations including: receiving, from an information processing apparatus, authentication information including identification information of a learner, comparing the authentication information with authentication information stored in the storage device to perform authentication processing of the learner, and generating session information in response to an authentication result; identifying the learner on the basis of the session information, acquiring, from the storage device, past learning history data and test result data associated with the learner, performing preprocessing on the acquired learning history data and test result data including correctness data, time data, and difficulty data to generate feature data, and inputting the feature data to a learning model using a machine learning algorithm to output an understanding score indicating an understanding level of the learner; generating a prompt sentence including condition information comprising at least a target field, a target item, a difficulty level, and a question format on the basis of the understanding score, and inputting the prompt sentence to a generative AI model to cause the generative AI model to generate question data including problem data, correct answer data, and explanation data in accordance with the understanding score; transmitting the question data to the information processing apparatus so as to cause the information processing apparatus to display a question, receiving answer information and answer time information of the learner from the information processing apparatus, and generating determination data indicating correctness and score data by comparing the answer information with the correct answer data; generating evaluation data including at least the problem data, the correct answer data, the answer information, the determination data, and the understanding score, generating a prompt sentence using the evaluation data, and inputting the prompt sentence to the generative AI model to cause the generative AI model to generate feedback data including feedback information indicating an error tendency and a misunderstanding of the learner and additional learning question data; transmitting the determination data, the score data, and the feedback data to the information processing apparatus so as to display the determination data, the score data, and the feedback data in real time, appending the determination data, the score data, the answer time information, and the feedback data as the learning history data to the storage device, and updating the understanding score sequentially on the basis of the learning history data; and changing the condition information and contents of the prompt sentence dynamically in accordance with the updated understanding score, and repeatedly instructing the generative AI model to generate subsequent questions adaptively for each learner. This enables the server to implement an improved technical pipeline that converts raw interaction logs into structured feature data, continuously refines machine-learned understanding scores, automatically synthesizes context-rich prompt sentences for the generative AI model, and delivers low-latency, adaptive question generation and feedback, thereby enhancing computational efficiency, reducing redundant processing, and improving the responsiveness and stability of the learning support system as a whole.

The term “server” refers to an electronic apparatus including at least one processor and at least one storage device, configured to execute computer programs and provide data processing and control functions accessible over a communication network.

The term “processor” refers to a hardware computation unit, such as a central processing unit or a processing core, configured to execute instructions of a computer program and perform arithmetic, logical, and control operations.

The term “storage device” refers to a non-transitory computer-readable medium, such as a memory device or a magnetic or solid-state storage unit, configured to store data and programs used by the processor.

The term “information processing apparatus” refers to a user-side electronic device, such as a terminal, client device, or computing node, configured to transmit and receive data to and from the server and to present information to a learner.

The term “learner” refers to a user who interacts with the system to perform learning activities and whose learning history and understanding level are analyzed by the server.

The term “authentication information” refers to data used to verify the identity of a learner, including at least identification information and optionally a secret such as a password, token, or credential.

The term “identification information” refers to data that uniquely or quasi-uniquely identifies a learner in the system, such as a user ID, account ID, or other identifier.

The term “authentication processing” refers to a sequence of operations in which the server compares received authentication information with stored authentication information to determine whether access by a learner is permitted.

The term “session information” refers to data generated by the server that represents a stateful association between a learner and the server over a period of interaction, and that is used to identify the learner in subsequent requests.

The term “learning history data” refers to data records representing past learning activities of a learner, including at least question identifiers, correctness results, timestamps, and optionally difficulty levels and feedback results.

The term “test result data” refers to data representing outcomes of assessments or tests performed by the learner, including scores, correctness information, and timing information.

The term “correctness data” refers to data indicating whether a learner's response to a problem is correct, incorrect, or partially correct.

The term “time data” refers to data representing temporal aspects of a learner's activity, including at least response times, submission times, or timestamps.

The term “difficulty data” refers to data representing a difficulty level associated with a problem, question, or learning item, such as a numerical level or categorical label.

The term “preprocessing” refers to a set of data transformation operations performed by the processor to prepare raw learning history data and test result data for input into a learning model, including operations such as filtering, normalization, encoding, and aggregation.

The term “feature data” refers to structured data, such as vectors or arrays, derived from learning history data and test result data through preprocessing, and suitable for input into a learning model.

The term “learning model” refers to a computational model, such as a statistical model or neural network, that is trained using a machine learning algorithm to infer patterns or predict quantities based on input feature data.

The term “machine learning algorithm” refers to a procedure or method that adjusts parameters of a learning model based on training data so that the model can perform tasks such as prediction, classification, or regression.

The term “understanding score” refers to a numerical value or set of values output from the learning model, representing an estimated understanding level of a learner regarding one or more topics or items.

The term “target field” refers to a subject area or domain, such as mathematics, language, or science, for which questions or learning content are generated.

The term “target item” refers to a particular topic, subtopic, concept, or skill within a target field for which questions or learning content are generated.

The term “difficulty level” refers to an indicator of the relative complexity or challenge of a question or learning content, represented as a discrete category or continuous value.

The term “question format” refers to a structural type of a question, such as multiple-choice format, descriptive format, fill-in-the-blank format, or other answer format.

The term “condition information” refers to information that constrains or specifies parameters for content generation, including at least a target field, a target item, a difficulty level, and a question format.

The term “prompt sentence” refers to a sequence of natural language text and optionally structured data that is input to a generative AI model to request generation of question data, feedback data, or other content.

The term “generative AI model” refers to a computational model, such as a generative neural network or language model, configured to generate output data including text or other content based on an input prompt.

The term “question data” refers to data generated by the generative AI model that includes at least problem data, correct answer data, and explanation data.

The term “problem data” refers to data representing the text or other representation of a question posed to a learner.

The term “correct answer data” refers to data representing at least one correct answer to a corresponding problem.

The term “explanation data” refers to data representing an explanation or reasoning related to a correct answer or solution of a problem.

The term “answer information” refers to data representing a response provided by a learner to a problem, including at least a selected option or entered text.

The term “answer time information” refers to data representing the time at which a learner submits an answer, or the duration taken by the learner to provide the answer.

The term “determination data” refers to data indicating a result of comparison between answer information and correct answer data, including at least a correctness indication.

The term “score data” refers to data indicating a quantitative evaluation of a learner's answer, such as points or a numerical score derived from determination data.

The term “evaluation data” refers to aggregated data including at least problem data, correct answer data, answer information, determination data, and an understanding score, which is used to generate feedback data.

The term “feedback data” refers to data generated by the generative AI model on the basis of evaluation data, including feedback information and additional learning question data.

The term “feedback information” refers to data indicating analysis of a learner's answer, such as error tendencies, likely misunderstandings, hints, and explanations.

The term “error tendency” refers to a pattern or type of mistake repeatedly made by a learner as inferred from multiple answers.

The term “misunderstanding” refers to an incorrect or incomplete conceptual grasp of a topic by a learner, as inferred from the learner's answer patterns.

The term “additional learning question data” refers to data representing further questions or tasks generated to reinforce concepts related to a learner's errors or misunderstandings.

The term “group-specific condition information” refers to condition information defined for each of a plurality of groups of learners, including at least a target field, a target item, and a difficulty level assigned to that group.

The term “group-specific problem data” refers to problem data generated for a particular group of learners based on group-specific condition information.

The term “group-specific feedback data” refers to feedback data generated for a particular group of learners based on group-specific condition information and the evaluation of answers from learners in that group.

The term “clustering processing” refers to a computational procedure that groups multiple learners or understanding scores into a plurality of clusters or groups based on similarity measures applied to feature data.

The term “real time” refers to a response behavior in which processing results, including determination data, score data, and feedback data, are transmitted and presented to the learner with a latency that is short enough to be perceived as immediate in the context of interactive learning.

The term “subsequent questions” refers to questions generated after prior questions have been answered, where the subsequent questions are adaptively determined based on updated understanding scores and learning history data.

The term “adaptive” refers to a behavior in which generated questions, feedback, or condition information are automatically varied in accordance with learner-specific data such as updated understanding scores, without manual intervention.

In one embodiment, a server, a terminal, and a user cooperate to implement an adaptive learning support system using a generative AI model. The server includes at least one processor, a main memory, a non-transitory storage device such as a magnetic or solid-state drive, and a network interface. The terminal includes at least one processor, a memory, a display, an input interface such as a touchscreen or keyboard, and a communication interface. The user operates the terminal to interact with the server over a network such as the Internet using standard protocols such as HTTPS.

The server uses an operating system such as a general-purpose server operating system and executes application software implemented, for example, using a programming language such as Python. The server uses frameworks and libraries such as a web framework, a numerical computation library, a machine learning library such as TensorFlow or PyTorch, and a data processing library such as NumPy or a tabular data library. The server also communicates with an external or internal generative AI model, for example a large language model implemented as a transformer-based neural network, via an application programming interface.

The server stores, on the storage device, learning history data, test result data, authentication information, session information, parameter data for a learning model, and log data. The server represents learning history data using structured records, for example in a relational database table where each record includes fields such as a user identifier, a problem identifier, a topic identifier, a subtopic identifier, a difficulty level, a correctness flag, a numeric score, a response time, a timestamp, and a reference to feedback data. The server stores such records in a data structure that can be accessed using indexed queries. The server thereby enables efficient retrieval of user-specific and topic-specific histories.

The server uses the machine learning library to define and store a learning model that estimates an understanding score for each learner. In one embodiment, the learning model is a feedforward neural network having an input layer, one or more hidden layers, and an output layer. The server configures the input layer to accept feature vectors derived from the learning history and test result data. The server configures each hidden layer as a fully connected layer with a non-linear activation function, such as a rectified linear unit. The server configures the output layer to output one or more continuous values, each representing an understanding score for a particular topic or subtopic, normalized for example to a range between zero and one.

The server trains the learning model by executing a supervised learning method using training data stored in the storage device. The server generates training examples by constructing feature vectors from historical learning data of multiple users and pairing them with ground-truth labels, such as manually assessed understanding levels or exam scores. The server uses an error function such as mean squared error or cross-entropy to calculate a loss between predicted scores and ground-truth labels. The server updates weights of the neural network using an optimization algorithm such as stochastic gradient descent or Adam. The server uses backpropagation to compute gradients of the loss with respect to weights and biases. The server optionally applies regularization techniques such as dropout or L2 regularization to prevent overfitting and improves generalization. The server optionally performs data augmentation at the feature level, for example by injecting small noise into response time features or sampling subsets of question histories, to increase robustness of the model.

The server preprocesses learning history data to generate feature data for the learning model. The server uses the numeric library to load raw records from the database into in-memory arrays or tabular structures. The server encodes categorical data such as topic identifiers and difficulty levels using one-hot encoding or embedding indices. The server normalizes continuous values such as response times and scores using scaling methods such as min-max normalization or z-score normalization. The server aggregates per-problem data into per-topic features, for example computing the average correctness rate per topic, the average response time per topic, the number of attempts per topic, and the distribution of difficulty levels encountered. The server concatenates such statistics into fixed-length feature vectors, which become the input to the learning model. By enforcing a specific data structure, the server enables efficient vectorized computation in the machine learning library and reduces cache misses and memory access overhead.

The server determines understanding scores by applying the trained learning model to the feature data. The server loads the trained model parameters into memory and places them on a hardware accelerator, such as a graphics processing unit, when available. The server inputs the feature vectors to the model and obtains output understanding scores in a batch-processing manner. The server maps these scores to internal difficulty categories using threshold rules, stored for example as configuration data, such as “score below 0.3 indicates low understanding,” “score between 0.3 and 0.7 indicates medium understanding,” and “score above 0.7 indicates high understanding.” The server stores the resulting understanding scores and categories in association with the learner in the storage device.

The server uses the understanding scores to programmatically construct a prompt sentence for the generative AI model. The server composes a natural language text that encodes, in a single string, target fields, target items, difficulty levels, question formats, and numeric understanding scores. The server may also embed prior error tendencies, such as repeated mistakes on a specific concept, into the prompt sentence. For example, the server generates a prompt sentence as follows:

“The learner has a low understanding level in calculus differentiation and integration (score: 0.30 out of 1.00). Please act as a math tutor. Please generate three basic multiple-choice questions about limits and first-order derivatives for high-school level. For each question, output: 1) the question text, 2) four answer choices labeled (A)-(D), 3) the correct answer label, 4) a brief explanation of the correct solution.”

The server constructs such prompt sentences using a templating mechanism that is parameterized by numerical values and identifiers stored in the data structures. The server thereby ensures that the generative AI model receives consistent, structured context data across multiple invocations. Because the server uses machine-computed understanding scores, time statistics, and difficulty distributions, the prompt sentence reflects an internal state that is not readily available to a human and thereby directs the generative AI model to generate content that is more precisely aligned with the learner's technical profile.

The server then transmits the prompt sentence to the generative AI model. In one embodiment, the generative AI model is deployed as a transformer-based language model accessible over an application programming interface. The server formats a request containing the prompt sentence and sends the request through the network interface using a protocol such as HTTPS. The server configures parameters of the generative AI model call, such as maximum output length, temperature, and top-k or top-p sampling settings, according to control data stored on the storage device. By controlling these parameters, the server balances creativity of question generation with stability and determinism required in an educational context.

The generative AI model generates question data that includes problem text, answer choices, correct answers, and explanations. The server receives the generated text as a response and parses it into structured fields using deterministic parsing rules or pattern matching. The server validates that each generated problem includes one and only one correct answer, that each multiple-choice question has the required number of options, and that the explanation sections conform to expected markers. The server assigns internal identifiers to each generated problem and stores the problem data, correct answer data, and explanation data in the storage device. The server transmits the generated question data to the terminal using a network protocol. The terminal receives the question data, stores it temporarily in memory, and renders the question text and answer choices on the display. The terminal formats the interface differently depending on the device type; for example, the terminal presents tap-selectable options on a touch device and clickable buttons on a personal computer. The user views the question and selects an answer through the input interface. The terminal packages the selected answer, the corresponding question identifier, and a timestamp or precise response duration and sends them back to the server.

The server receives the answer information and answer time information and evaluates the answer. The server retrieves the correct answer data corresponding to the question identifier from the storage device. The server compares the answer information to the correct answer data using exact matching or, in some embodiments, approximate matching for free-text answers using string similarity metrics. The server generates determination data such as a binary correctness flag or a partial credit score. The server calculates score data by applying a scoring function stored in configuration, which may depend on correctness, difficulty, and response time. The server writes the new record to the learning history data structure, including the correctness flag, numerical score, and response time. By storing these records with precise timestamps and question identifiers, the server preserves a detailed trace of user interactions.

The server constructs evaluation data from the problem data, correct answer data, answer information, determination data, and understanding scores. The server then composes a second prompt sentence for the generative AI model, which instructs it to generate personalized feedback. For example, the server may generate a prompt sentence as follows:

“You are a supportive math tutor. Question: [insert generated calculus question text] Correct answer: [insert correct option and reasoning] Learner's answer: [insert learner's chosen option] Please: 1) say whether the learner's answer is correct or incorrect, 2) if incorrect, explain the correct reasoning step by step, 3) briefly point out the learner's likely misunderstanding, 4) give one simple follow-up hint problem to reinforce the concept.”

The server again uses a templated structure to embed the problem text, correct reasoning, and learner answer. The server sends this prompt sentence to the generative AI model using the same network interface and receives feedback data. The server parses the returned text to extract an explanation section, a misunderstanding description, and optionally a follow-up question. The server stores these feedback components in the storage device as feedback data associated with the learner and the specific question.

The server transmits the determination data, score data, and feedback data to the terminal. The terminal presents the correctness status and score and displays the explanation text and hints on the display in near real time. The user can thus receive immediate, context-rich feedback. The server simultaneously appends the answer information, determination data, score data, answer time information, and feedback data to the learning history data. In subsequent analysis cycles, the server includes this newly appended data in the feature generation pipeline, thereby updating the understanding scores.

The server improves computational efficiency by organizing the data flow as a series of vectorized operations. For example, the server processes batches of feature vectors for multiple questions or multiple learners simultaneously on the hardware accelerator. The server caches recently used model parameters and configuration data in memory to reduce storage access latency. The server also reduces network overhead by aggregating multiple questions and feedback requests into batched generative AI model calls when permitted by latency requirements. By constructing prompt sentences programmatically and reusing template segments, the server minimizes serialization cost and reduces errors compared to manual prompt crafting.

The server differs from a mere automation of human assessment because the server implements a closed technical loop in which internal model states (understanding scores, error tendencies) directly and algorithmically shape the content and timing of subsequent generative calls, through quantified thresholds and parameterized templates. The server uses rule sets that are not the direct codification of pedagogical heuristics, but rather are derived from numerical constraints and model outputs, such as using response time distributions to influence difficulty. For example, the server may treat a consistently short response time with correct answers as a signal to increase difficulty, while also modifying the prompt sentence to request problems that emphasize edge cases or unusual problem structures. This is a non-conventional use of interaction metrics to control an external generative AI model and thereby improves the technical behavior of the entire system.

In another embodiment, the server performs clustering processing on understanding scores of multiple learners. The server collects feature data across many users and uses an unsupervised learning algorithm such as k-means clustering or a Gaussian mixture model to partition the learners into groups based on multi-dimensional understanding profiles. The server defines group-specific condition information for each cluster, including preferred topics and difficulty bands observed to be suitable for that group. The server generates group-specific prompt sentences that describe the group characteristics, such as “learners in this group struggle with basic integration but have strong algebra skills,” and requests the generative AI model to produce question sets tailored to clusters rather than individuals. This allows the server to pre-generate and cache group-optimized question banks, which reduces per-learner generative calls, reduces network traffic, and improves scalability under heavy load.

In a further embodiment, the server adjusts internal thresholds and learning model parameters dynamically based on system-level metrics such as average processing latency and error rates. The server may, for example, reduce the complexity of feature vectors or temporarily limit the number of topics predicted in a single pass if processing load exceeds a certain threshold. The server may adjust the maximum length of generative AI model outputs described in the prompt sentence to keep response times within target bounds. By managing these parameters adaptively, the server optimizes resource utilization and maintains stable quality of service, thus directly improving computer performance.

In yet another embodiment, the server uses alternative learning model architectures, such as a recurrent neural network or a transformer-based encoder, to capture temporal patterns in learning history. The server orders learning records by timestamp and feeds sequences of correctness and response time data into a sequence model. The server uses an appropriate loss function, such as cross-entropy over future correctness, to train the model to predict probability of success on future questions. The server then uses these probabilistic outputs as understanding scores and incorporates them into prompt sentences. Using sequence models, the server can distinguish between learners with improving trends and learners with inconsistent performance, even when average scores are similar. This additional temporal structure further refines the generative AI model's inputs and leads to more targeted question generation.

The server thereby implements a concrete, structured data pipeline: acquisition of raw interaction records, feature construction using specific numerical operations, modeling with trained neural networks, prompt sentence construction with encoded internal states, generative AI model invocation, structured parsing and validation of generated outputs, storage updates, and iterative refinement of the model state. Each stage operates over explicit data structures and uses specified algorithms and parameters, and each stage contributes to technical effects such as reduced latency, improved prediction accuracy, and controlled network load. As a result, the system does not merely implement an abstract educational idea, but rather realizes a specific improvement in computer-implemented processing for adaptive content generation and feedback management.

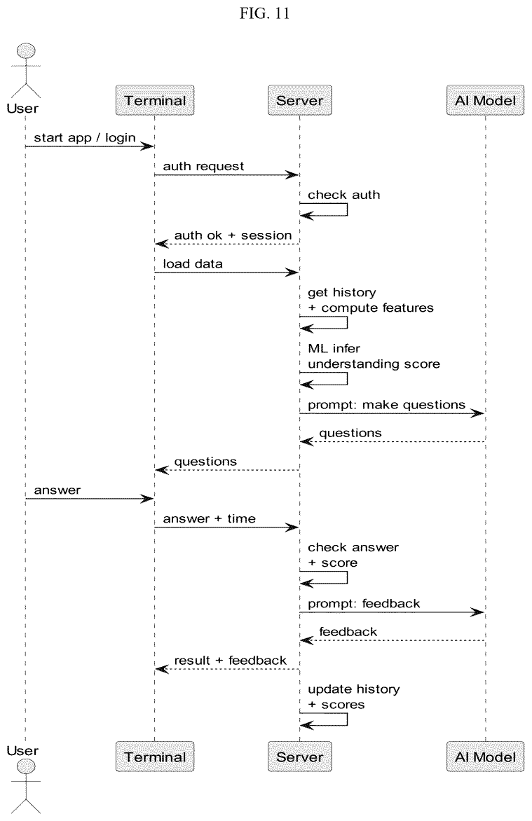

The following describes the processing flow using FIG. 11.

### Step 1:

The user operates the terminal to launch a learning application or web browser and to open a login screen. The terminal receives input in the form of a user identifier and a password entered by the user. The terminal performs basic validation such as checking for empty fields and allowable character sets, and the terminal outputs a formatted authentication request that includes the user identifier and password. The terminal sends this authentication request to the server over a secure communication channel.

### Step 2:

The server receives the authentication request as input and parses the included user identifier and password. The server performs a cryptographic hash operation on the received password using a stored hashing algorithm and salt parameters, and the server queries a storage device with the user identifier to retrieve a stored password hash and account status. The server compares the computed hash with the stored hash and evaluates the account status; based on this data processing, the server outputs an authentication result indicating success or failure and, in the case of success, generates session information including a session token. The server sends the authentication result and, when applicable, the session token to the terminal.

### Step 3:

The terminal receives the authentication result and session token as input. The terminal determines, based on the result, whether login is successful. If the login is successful, the terminal stores the session token in a secure memory region and updates the display to show a home or dashboard screen. The terminal outputs a subsequent data request that includes the session token and a request type indicating that learning data or an initial question set should be loaded. The terminal sends this request to the server.

### Step 4:

The server receives the data request and session token as input. The server validates the session token by checking it against session records in the storage device and, upon successful validation, the server identifies the corresponding learner identifier. The server then queries learning history tables and test result tables using the learner identifier as a key and aggregates all matching records. The server performs data selection and aggregation operations to construct a unified learning history dataset; the server outputs this dataset as in-memory structured data, such as arrays or tables, and holds it for further analysis.

### Step 5:

The server receives the learning history dataset as input for preprocessing. The server filters out incomplete or corrupted records by evaluating field completeness and valid value ranges. The server encodes categorical attributes, such as topic and difficulty level, using numerical encoding schemes, and the server normalizes continuous attributes, such as response time and scores, using scaling functions. The server then groups records by topic and computes statistical measures such as average correctness rate, average response time, number of attempts, and difficulty distribution. The server outputs a set of feature vectors, each feature vector representing a topic-wise summary of the learner's performance, and stores these feature vectors in memory.

### Step 6:

The server receives the feature vectors as input to a learning model implemented with a machine learning library. The server loads model parameters and architecture, such as a multi-layer neural network, into memory and, if available, onto a hardware accelerator. The server applies the feature vectors to the model's input layer and executes a forward computation through hidden layers with activation functions, thereby performing matrix multiplications and non-linear transformations. The server outputs, for each topic, an understanding score as a continuous value between a minimum and maximum boundary. The server stores these understanding scores in association with the learner and makes them available for content generation.

### Step 7:

The server receives the understanding scores as input for prompt construction. The server selects one or more target fields, target items, and desired difficulty levels based on the understanding scores using predetermined threshold rules; for example, the server chooses basic level questions for topics with low scores and advanced questions for topics with high scores. The server embeds the selected topics, numeric scores, and desired question formats into a natural language template to generate a prompt sentence. The server outputs a complete prompt sentence such as: “The learner has a low understanding level in calculus differentiation and integration (score: 0.30 out of 1.00). Please act as a math tutor. Please generate three basic multiple-choice questions about limits and first-order derivatives for high-school level. For each question, output: 1) the question text, 2) four answer choices labeled (A)-(D), 3) the correct answer label, 4) a brief explanation of the correct solution.” The server sends this prompt sentence to the generative AI model.

### Step 8:

The server receives, from the generative AI model, generated text as input, the text including problem statements, answer options, correct answers, and explanations. The server parses the text using pattern matching or predefined delimiters to separate individual questions and their components. The server validates each parsed unit by checking that each question has a sufficient number of options, a single correct answer, and an associated explanation. The server outputs structured question data records that include problem data, correct answer data, and explanation data, and stores these records in the storage device. The server then sends the structured question data to the terminal.

### Step 9:

The terminal receives the structured question data as input. The terminal interprets fields such as problem text and answer options and constructs a graphical interface on the display showing the questions and selectable answers. The terminal outputs an interactive question screen and waits for user operations. When the user selects an answer and submits it, the terminal records the selected option, the question identifier, and the time at submission, then outputs answer information and answer time information as a response payload. The terminal sends this payload to the server.

### Step 10:

The server receives the answer information and answer time information as input. The server retrieves the corresponding question record and correct answer data from the storage device using the question identifier. The server compares the learner's answer with the correct answer and computes determination data, such as a binary correctness flag or a partial credit value. The server calculates score data by applying a scoring function that may incorporate correctness, difficulty level, and response time, for example reducing the score when the response time is unusually long. The server outputs updated determination data and score data and writes a new entry into the learning history dataset, thereby extending the historical record for later analysis.

### Step 11:

The server receives the problem data, correct answer data, answer information, determination data, and current understanding scores as input to form evaluation data. The server composes a second prompt sentence for feedback generation by embedding these elements into a feedback template. The server may generate a prompt sentence such as: “You are a supportive math tutor. Question: [insert generated calculus question text] Correct answer: [insert correct option and reasoning] Learner's answer: [insert learner's chosen option] Please: 1) say whether the learner's answer is correct or incorrect, 2) if incorrect, explain the correct reasoning step by step, 3) briefly point out the learner's likely misunderstanding, 4) give one simple follow-up hint problem to reinforce the concept.” The server outputs this feedback prompt sentence and sends it to the generative AI model.

### Step 12:

The server receives feedback text generated by the generative AI model as input. The server parses the text into segments such as a correctness description, a step-by-step explanation, a misunderstanding description, and a follow-up hint question. The server organizes these segments into feedback data records and associates them with the learner and the corresponding question identifier. The server outputs structured feedback data and stores it in the storage device. The server sends the feedback data, along with the determination data and score data, to the terminal.

### Step 13:

The terminal receives the feedback data, determination data, and score data as input. The terminal updates the display to show whether the answer was correct or incorrect, the score obtained, and the explanation and hints contained in the feedback data. The terminal formats the explanation for readability, for example using line breaks or bullet-style layout, and the terminal outputs an updated learning screen that allows the user to review the explanation and optionally proceed to another question or topic.

### Step 14:

The server receives newly appended learning history data as input, including the latest determination data, score data, answer time information, and feedback data. The server integrates these new records into the existing learning history dataset, updates statistical aggregates such as average correctness and response time per topic, and reconstructs feature vectors to reflect the extended history. The server then re-applies the learning model to the updated feature vectors, performing the same data processing and numerical computation, to output updated understanding scores. The server stores the updated understanding scores and uses them to adjust the parameters used in the next prompt sentence, thereby closing the loop and enabling continuous, adaptive refinement of content generation.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional computer-implemented learning support systems, a processor typically recommends educational content or generates questions based on static rules or coarse-grained learner attributes. Such systems often rely on manually designed recommendation logic or simple scoring functions that do not fully exploit detailed behavioral logs, contextual information within the content, or real-time interaction during viewing or browsing. As a result, the system cannot flexibly adapt to nuanced changes in a learner's interests or comprehension level, and cannot provide timely explanatory feedback when the learner encounters difficult information within a content item.

Further, known systems that employ machine learning for personalization generally separate the recommendation pipeline from the explanation or feedback pipeline. Recommendation models may use aggregated user profiles, while explanation mechanisms rely on pre-authored texts or fixed glossaries. This separation leads to duplicated processing, inconsistent personalization, and increased computational overhead, because different modules maintain separate representations of learner state and content state. Additionally, such systems often treat content difficulty as a static property, without dynamically determining which specific terms or expressions are difficult for a particular learner in a particular context and time within the content.

Moreover, while large-scale generative AI models have emerged as powerful tools for generating natural language content, conventional systems tend to use these models in an ad hoc manner, for example by manually crafting prompts for each use case. In such configurations, there is no integrated mechanism by which the processor automatically constructs structured prompt sentences based on machine-learned learner profiles, content metadata, and real-time interaction logs, and no mechanism to systematically use the same generative AI model for both content recommendation and context-aware explanation generation. Consequently, the generative AI model is underutilized, the output is inconsistent, and the computational resources of the system are not effectively leveraged.

From the perspective of computer technology, there is therefore a need for an improved information processing architecture in which a processor: (i) continuously acquires and analyzes past learning history and real-time behavior data to build and update a machine-readable learner profile; (ii) automatically identifies difficult information at a fine-grained level within educational content based on both the content information and the learner profile; and (iii) programmatically generates structured prompt sentences that direct a generative AI model to execute both recommendation and explanation tasks in an integrated, context-aware manner. Achieving such integration can reduce redundant computation, improve data flow efficiency, and enhance the quality and timeliness of system outputs, thereby improving the functioning of the computer system itself.

The specific processing by the specific processing unit 290 of the data processing device 12 in Application Example 1 is realized by the following means.

The present invention provides a server comprising a processor and a storage device, the processor being configured to execute instructions to acquire past learning history data of a learner from the storage device, analyze an interest and a tendency of the learner based on the learning history data, and generate a machine-readable learner profile; to generate a first prompt sentence including recommendation request content, the recommendation request content being generated based on the learner profile and attribute information of each educational content included in an educational content set and being configured to cause a generative AI model to output recommendation information of educational content suitable for the learner; to generate a second prompt sentence including explanation request content, the explanation request content being generated based on content information of educational content and the learner profile and being configured to cause the generative AI model to output explanation information for difficult information included in the educational content; to input the first prompt sentence and the second prompt sentence into the generative AI model via a communication interface and acquire, from the generative AI model, the recommendation information and the explanation information; to transmit the recommendation information and the explanation information to a terminal device having a display device and control the terminal device to display the recommendation information and the explanation information in association with educational content being viewed or browsed by the learner; to acquire, as behavior history data, a selection operation, a browsing operation, or an evaluation operation performed by the learner with respect to the recommendation information and the explanation information and update the learner profile based on the behavior history data; and to specify, as difficult information, a term or an expression having a high possibility of being difficult for the learner based on the content information and the learner profile, and generate an explanation prompt sentence including the term or the expression specified as the difficult information and context information around the term or the expression, the explanation prompt sentence instructing generation of explanation information according to a comprehension level and an interest of the learner, and input the explanation prompt sentence into the generative AI model. This enables an improved computer-implemented learning support system in which the processor and storage device cooperate to dynamically construct and update learner profiles, to programmatically generate structured prompt sentences that unify recommendation and explanation tasks, to offload complex natural language generation to a generative AI model in a controlled and context-aware manner, and to provide real-time, personalized recommendation information and explanation information with reduced redundancy and improved data flow efficiency, thereby enhancing the overall performance, adaptability, and responsiveness of the information processing system.

The term “server” refers to an information processing apparatus including at least one processor and at least one storage device, configured to execute programs for acquiring, analyzing, and managing learning-related data, generating prompt sentences, communicating with a generative AI model, and transmitting information to a terminal device.

The term “processor” refers to a hardware computation unit, such as a central processing unit or equivalent logic circuitry, configured to execute instructions that implement data acquisition, analysis, profile generation, prompt generation, communication control, and output control functions of the system.

The term “storage device” refers to a computer-readable medium, such as a memory device or a non-transitory storage apparatus, configured to store learning history data, content information, learner profiles, behavior history data, and programs executed by the processor.

The term “learner” refers to a user of the system who consumes educational content, interacts with recommendation information and explanation information, and whose learning history and behavior history are analyzed by the processor.

The term “learning history data” refers to electronic data representing past learning activities of a learner, including at least one of identifiers of educational content presented to the learner, timestamps, viewing or browsing durations, completion statuses, and interaction records.

The term “behavior history data” refers to electronic data representing actions performed by the learner with respect to recommendation information, explanation information, and educational content, including at least one of selection operations, browsing operations, evaluation operations, and interaction patterns over time.

The term “learner profile” refers to structured electronic information generated and updated by the processor, representing characteristics of the learner, including at least one of interests, tendencies, comprehension levels, preferred topics, and usage patterns, and being used as input to recommendation and explanation processes.

The term “educational content” refers to digital instructional material, such as text, audio, video, or interactive media, which is presented to the learner for purposes of learning or skill acquisition and whose content information is processed by the system.

The term “content information” refers to metadata and internal data of educational content, including at least one of titles, descriptions, topic classifications, transcripts, time-aligned text segments, and attribute information associated with the educational content.

The term “attribute information” refers to descriptive data associated with each educational content item, including at least one of category, genre, difficulty level, topic tags, and length, which is used by the processor to generate recommendation request content.

The term “educational content set” refers to a collection of multiple educational content items managed by the system, from which the processor selects one or more candidate contents for recommendation to the learner.

The term “terminal device” refers to an end-user device, such as a computing terminal or display apparatus, configured to receive recommendation information and explanation information from the server and to present educational content and related information to the learner via a display device.

The term “display device” refers to a visual output apparatus included in or connected to the terminal device, configured to display educational content, recommendation information, and explanation information to the learner.

The term “recommendation information” refers to electronic information generated or obtained by the processor, indicating one or more educational content items suitable for the learner, and optionally including identifiers, titles, summaries, and reasons for recommendation.

The term “explanation information” refers to electronic information generated or obtained by the processor, including natural language explanations, clarifications, or additional details for difficult information contained in educational content, and tailored to a comprehension level of the learner.

The term “difficult information” refers to a term, expression, or concept included in educational content that the processor determines, based on content information and a learner profile, to have a high likelihood of being difficult for the learner to understand.

The term “prompt sentence” refers to text-based instruction data constructed by the processor, which specifies at least one of recommendation request content and explanation request content, and is input into a generative AI model to control generation of recommendation information or explanation information.

The term “recommendation request content” refers to a portion of a prompt sentence that describes conditions, constraints, and contextual information for selecting or ranking educational content items suitable for the learner.

The term “explanation request content” refers to a portion of a prompt sentence that describes conditions, constraints, and contextual information for generating explanation information about difficult information in educational content.

The term “explanation prompt sentence” refers to a prompt sentence specifically configured to instruct a generative AI model to generate explanation information regarding difficult information, including at least a difficult term or expression, context information, and indications of the learner's comprehension level and interests.

The term “generative AI model” refers to a machine-learned model, such as a large-scale natural language generation model, that accepts a prompt sentence as input and outputs generated text including recommendation information or explanation information based on the prompt sentence.

The term “clustering technology” refers to a machine learning method used by the processor to classify learners or content items into groups based on similarity of profile data or behavior history data, without requiring explicit labels.

The term “interest” refers to a preference tendency of the learner inferred from learning history data and behavior history data, indicating favored topics, genres, or types of educational content.

The term “tendency” refers to a behavioral pattern of the learner inferred from learning history data and behavior history data, including at least one of typical viewing durations, completion ratios, interaction frequencies, and time-of-day usage patterns.

The term “comprehension level” refers to an estimated degree of understanding or proficiency of the learner regarding certain topics or difficulty levels, inferred from learning history data, behavior history data, and evaluation results.

The term “context information” refers to surrounding content information related to a term or expression identified as difficult information, including at least one of neighboring sentences, paragraphs, time-aligned transcript segments, and associated topic metadata.

The term “real-time feedback” refers to explanation information or other system responses that are generated and provided to the learner while the learner is viewing or browsing educational content, with latency low enough that the learner can use the information during ongoing consumption of the content.

The term “playback time information” refers to electronic data indicating a temporal position within educational content, such as a timestamp or elapsed time from a start of playback, transmitted from the terminal device to the server.

The term “content identification information” refers to electronic data that uniquely identifies a particular educational content item within the system, such as a content identifier or resource locator.

The term “selection operation” refers to an action by which the learner chooses or activates recommendation information or educational content, such as clicking, tapping, or otherwise indicating selection via the terminal device.

The term “browsing operation” refers to an action by which the learner navigates, scrolls, or views recommendation information, explanation information, or educational content on the terminal device without necessarily selecting or completing the corresponding content.

The term “evaluation operation” refers to an action by which the learner explicitly indicates an assessment of recommendation information, explanation information, or educational content, such as providing ratings, feedback markings, or responses to evaluation prompts.

In one embodiment, a server provides an improved computer-implemented learning support system that cooperates with a terminal and a user. The server includes at least one processor and at least one storage device. The processor executes programs that implement data acquisition, analysis, learner profile generation, prompt sentence generation, interaction with a generative AI model, and delivery of recommendation information and explanation information to the terminal. The storage device stores learning history data, behavior history data, content information, learner profiles, and model parameters.

The server uses typical computing hardware such as a multi-core CPU and, optionally, a graphics processing unit. The server runs an operating system such as a general-purpose server operating system and executes application programs written in a high-level language such as a scripting language or a compiled language. The server employs software libraries for machine learning and numerical computation, such as a numerical computation library, a deep learning framework, and a machine learning toolkit. The server also uses a database management system to store relational tables and possibly a key-value store for caching learner profiles and model outputs. The terminal is a computing device including a display device, an input interface such as a touch panel, and a communication module. The terminal executes a client application that communicates with the server via a network protocol such as HTTPS. The terminal receives recommendation information and explanation information from the server and displays them to the user in association with educational content. The user interacts with the terminal to start playback, select recommended content, view explanations, and provide explicit evaluations. The server stores learning history data in a structured data schema. The server uses a table for user accounts, a table for educational content, a table for learning history, and a table for behavior history. The server includes in the learning history table fields such as user identifier, content identifier, start time, stop time, playback duration, completion flag, and device type. The server includes in the behavior history table fields such as user identifier, recommendation item identifier, explanation item identifier, operation type (selection, browsing, evaluation), and timestamp. The server stores content information including title, topic tags, difficulty level, transcript text, time alignment markers, and attribute information such as genre and media type. The server represents each learner profile as a structured data object. The server uses a feature vector format that includes numerical features and categorical features. The numerical features include, for example, average viewing duration per session, average completion ratio, counts of contents per topic category, and frequency of requesting explanations. The categorical features include, for example, most frequent topics, preferred difficulty levels, and preferred content formats. The server stores the learner profile either in a dedicated profile table of the relational database or in a key-value store keyed by user identifier.

The server uses machine learning algorithms to transform raw logs into learner profiles. The server uses the machine learning toolkit to perform feature extraction. The server encodes categorical features with one-hot encoding and normalizes numerical features using methods such as min-max scaling or z-score normalization. The server uses clustering technology such as k-means clustering to identify groups of similar learners. For this purpose, the server chooses a number of clusters and an appropriate distance metric (for example, Euclidean distance on normalized feature vectors). The server initializes cluster centroids with a seeding method and iteratively updates the centroids until convergence. The server assigns each learner to a cluster and records the cluster identifier as part of the learner profile.

The server uses a deep learning framework to implement a recommendation model. In one embodiment, the server defines a neural network architecture for recommendation that includes an embedding layer for user identifiers, an embedding layer for content identifiers, and at least one hidden layer. The server concatenates user embeddings, content embeddings, and additional feature vectors (including topic tags and difficulty features) and feeds the concatenated vector into fully connected layers with non-linear activation functions. The server uses an output layer with a sigmoid or softmax function to estimate a relevance score for each candidate content. The server trains this network on training data derived from learning history data, where positive examples are pairs of learner and content that were consumed with high completion or positive evaluation, and negative examples are pairs corresponding to skipped or quickly abandoned content. The server minimizes a loss function such as binary cross-entropy or sampled softmax loss. The server updates model weights using an optimization algorithm such as stochastic gradient descent with momentum or Adam. The server periodically retrains or fine-tunes the model as new history data accumulate.

The server also uses a neural network to assess difficulty of content segments. In one embodiment, the server extracts transcript segments around specific timestamps. The server tokenizes the text, converts tokens into word embeddings or subword embeddings, and feeds the sequence into a sequence model such as a bidirectional recurrent neural network or a transformer encoder. The server concatenates the text representation with learner profile features to produce a joint representation. The server uses a classification head that outputs a difficulty probability. The server trains this model on labeled data where difficult segments are annotated by educators or inferred from repeated explanation requests. The server uses a cross-entropy loss and updates parameters in a similar manner.

The server uses a generative AI model as a natural language generation engine. The server may host this model locally or access it through a remote API. The generative AI model is a sequence-to-sequence neural network, such as a transformer-based language model, trained on large-scale text corpora. The model has multiple attention layers, feed-forward layers, and layer normalization units. Model parameters are fixed during inference in the deployed system. The server interacts with the generative AI model by constructing prompt sentences and passing them as input sequences to the model. The server receives as output generated tokens representing recommendation descriptions and explanations. The server sets generation parameters such as maximum length, temperature, and top-k or nucleus sampling thresholds to balance diversity and determinism.

The server constructs prompt sentences using structured templates. The server uses the learner profile, the set of candidate contents, and the detected difficult information to fill the templates. In one example, the server constructs a recommendation prompt sentence as plain text:

“Using the following learner profile and viewing history, recommend the next three educational contents for this learner.

Learner profile: prefers beginner-level science and technology topics, typically watches videos to completion, often requests explanations for physics terms.

### Candidate Contents:

1. Introductory physics: motion and forces (beginner, video, 30 minutes)
2. Quantum mechanics: wave-particle duality (intermediate, video, 45 minutes)
3. Basic statistics: probability and random variables (beginner, video, 40 minutes)

Please output three recommended items with short reasons for each recommendation.”

The server also constructs explanation prompt sentences. In one example, the server generates:

“The learner is currently watching an introductory video about quantum mechanics.

Transcript segment: ‘In this chapter we will explain quantum entanglement and how it differs from classical correlations.’

The learner is a non-expert and prefers simple, intuitive explanations.

Explain the term ‘quantum entanglement’ in about 150 words, using plain language and everyday analogies, and avoid equations and advanced jargon.”

The server formats these prompt sentences as plain text and sends them to the generative AI model through a communication interface. The server receives generated text and performs post-processing such as trimming extra headers, enforcing a maximum length, and checking that the output language matches the system configuration.

The terminal receives recommendation information and explanation information from the server. The terminal stores the information in local memory and renders it on the display device. The terminal arranges recommendation items in a dedicated area, showing titles, thumbnails, and short reasons for recommendation. The terminal overlays explanation information near the bottom or side of the screen while educational content is played. The terminal associates each explanation with a timestamp and a term identifier. The user can tap or otherwise interact with the explanation panel to expand or close it. The terminal sends interaction events back to the server as behavior history data.

The server uses the interaction events to refine learner profiles. The server increases a weight for topics corresponding to recommendation items that were frequently selected and completed. The server decreases weights for topics associated with items that were quickly abandoned. The server adjusts a difficulty preference parameter based on whether the learner frequently requests explanations. The server recalculates the numerical feature vector and updates the cluster assignment using the clustering algorithm. The server then generates updated prompt sentences reflecting the new learner profile. In this manner, the server and storage device cooperate to form a feedback loop that continuously improves personalization.

The server structures internal data flow through modules. A data acquisition module writes logs to the relational database. A feature extraction module reads logs, performs joins with content information, and outputs feature vectors. A profile module aggregates feature vectors into learner profiles. A difficulty detection module uses the difficulty classifier to assign difficulty scores to segments and terms. A prompt generation module takes profiles, candidate lists, and difficult segments and constructs prompt sentences. A communication module sends requests to and receives responses from the generative AI model. A response integration module merges model outputs with internal identifiers and forwards them to the terminal. This modular structure reduces coupling and allows optimized computation in each step.

The server improves computer technology in several ways. First, the server reduces redundant processing by using a single generative AI model for both recommendation text generation and explanation generation, controlled by systematically constructed prompt sentences that encode machine-readable profile information. Because the server transforms internal feature vectors and content metadata into structured prompt sentences according to defined templates and rules, the server avoids repeated implementation of separate text rendering pipelines and reduces memory use and processing overhead.

Second, the server improves recommendation and explanation accuracy by integrating learner profile features at both the machine learning layer and the generative layer. The server uses numerical learner profiles as input to neural recommendation and difficulty models, which directly affects relevance scores and difficulty probabilities. The server then encodes high-level results (for example, “beginner”, “prefers science videos”) into the prompt sentences, so the generative AI model receives a context that reflects machine-learned signals rather than manually input preferences. This combined architecture yields higher personalization accuracy and lower error rates compared to ad hoc prompting without learned profiles.

Third, the server improves processing speed and resource utilization. The server precomputes learner profiles and difficulty scores in batch processes and caches the results in the storage device. Therefore, at the time of recommendation or explanation, the server only performs lightweight retrieval, prompt assembly, and generative inference. The server also narrows down candidate contents using the recommendation model before constructing prompt sentences, thereby reducing prompt length and generative model computation time. This reduction in prompt size and model calls leads to lower latency and communication overhead between the server and the generative AI model.

Fourth, the server implements non-conventional data flow and control logic that differs from manual or rule-based systems. The server does not merely automate human selection and explanation; instead, the server uses a particular sequence of machine learning operations—feature normalization, clustering, neural recommendation scoring, difficulty classification, and template-based prompt construction—to produce inputs that a generative AI model cannot be expected to construct from raw logs alone. The server encodes numeric difficulty signals and cluster identifiers into discrete textual descriptors in the prompt sentences in a consistent manner, thereby enabling the generative AI model to condition its generation on fine-grained machine-learned attributes. This hybrid design is specifically tailored to the computational characteristics of modern generative models and improves the effectiveness and efficiency of their use.

Alternative embodiments are also possible. In another embodiment, the server uses a matrix factorization model instead of or in addition to a neural network for recommendation. The server factorizes a user-content interaction matrix into low-dimensional latent vectors and uses these vectors as part of the learner profile. The server still encodes the latent preferences as descriptive text in prompt sentences for the generative AI model. In yet another embodiment, the server uses a transformer-based encoder to process transcript segments and learner features jointly for difficulty prediction, with multi-head attention mechanisms focusing on terms that historically triggered explanation requests. The server may adjust the explanation generation strategy depending on the predicted difficulty score, for example generating brief tooltips for low difficulty scores and longer narratives for high difficulty scores.

In another embodiment, the server executes the generative AI model locally. The server stores model parameters in the storage device and loads them into memory at startup. The server implements optimized inference routines that use batch processing of prompt sentences and hardware accelerators. The server schedules inference jobs to exploit parallelism. This local deployment reduces network latency and mitigates dependency on external services. The server can further prune the model or apply quantization techniques to reduce memory usage and improve inference throughput, directly enhancing the technical performance of the system. Through these embodiments, the server, terminal, and user cooperate in a computer-implemented system where specific data structures, algorithms, and generative AI interactions are used to provide real-time, personalized learning support. The system improves technical aspects such as processing speed, accuracy of personalization, data flow efficiency, and utilization of generative models, beyond a mere automation of human tasks.

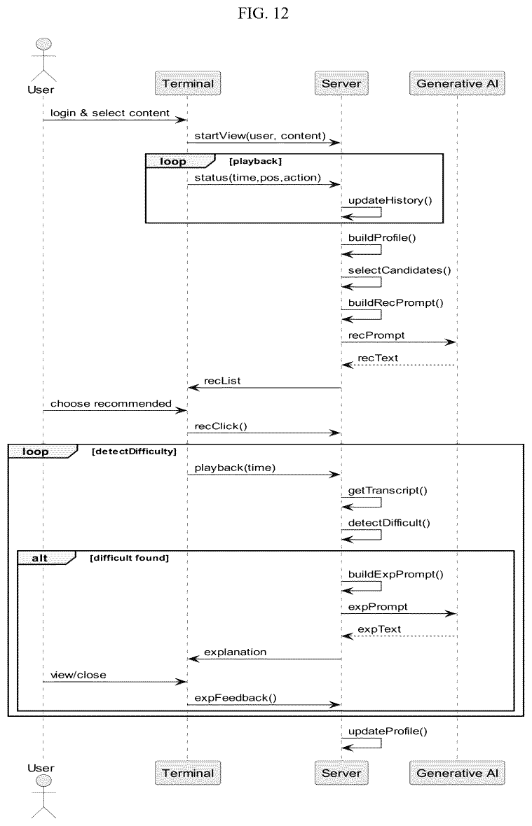

The following describes the processing flow using FIG. 12.

### Step 1:

The terminal acquires user identification information and content identification information when the user logs in and starts viewing or browsing educational content.

The input is user credentials, a selected content identifier, and initial playback parameters.

The terminal sends, to the server, a start-view event including the user identifier, the content identifier, a timestamp, and device information.

The output is a structured event message transmitted over a network from the terminal to the server.

### Step 2:

The server stores the received start-view event in a learning history table of a database.

The input is the event message containing user identifier, content identifier, and timestamp.

The server writes a new record into the learning history table and sets initial fields such as start time and device type, leaving end time and completion flag unset.

The output is an updated learning history table that now contains a persistent record representing the beginning of a viewing session.

### Step 3:

The terminal periodically sends playback status updates to the server while the user is viewing the content.

The input is the current playback time within the content, pause or resume actions, and any seek operations performed by the user.

The terminal packages these values into status messages and transmits them to the server at predefined intervals or when significant changes occur.

The output is a stream of playback status messages available to the server for analysis.

### Step 4:

The server updates learning history records and accumulates behavior history data based on the playback status messages.

The input is the playback status stream containing timestamps, playback positions, and actions.

The server calculates viewing duration by subtracting the start time from the current timestamp, marks completion when the playback position reaches a threshold near the end of the content, and records actions such as skips or pauses as behavior history entries.

The output is an updated learning history table with accurate duration and completion fields and a behavior history table populated with detailed interaction records.

### Step 5:

The server constructs or updates a learner profile for the user using the stored learning history and behavior history.

The input is a set of records retrieved from the database for the user, including watched contents, durations, completion flags, and interaction types.

The server aggregates these records to compute numerical features (such as average session length, completion ratio per topic, and frequency of explanation requests) and categorical features (such as dominant topics and preferred difficulty). The server normalizes numerical features and encodes categorical features as one-hot vectors, then stores the resulting feature vector and derived attributes as the learner profile.

The output is an up-to-date learner profile object associated with the user identifier.

### Step 6:

The server groups learners into clusters using clustering technology to identify similar learning patterns.

The input is a collection of learner profiles represented as feature vectors.

The server runs a clustering algorithm such as k-means by repeatedly assigning each learner profile to the nearest cluster centroid and recomputing centroids until convergence. Based on the final clustering, the server assigns a cluster identifier to each learner profile and records summary characteristics for each cluster.

The output is an augmented set of learner profiles that include cluster identifiers and cluster-level statistics used for subsequent recommendations and explanations.

### Step 7:

The server selects candidate educational contents for recommendation using a recommendation model.

The input is the learner profile for the current user, including the cluster identifier, and a catalog of available educational contents with attribute information.

The server filters out contents already completed or not available, transforms user and content identifiers into embeddings, and passes them along with feature vectors into a neural recommendation model. The model computes relevance scores for each candidate, and the server sorts contents according to the scores and selects a subset as recommendation candidates.

The output is a ranked list of candidate content identifiers and associated relevance scores for the user.

### Step 8:

The server generates a recommendation prompt sentence for the generative AI model based on the learner profile and the candidate contents.

The input is the learner profile, including interests and difficulty preferences, and the ranked list of candidate contents with titles, topics, difficulty levels, and durations.

The server fills a textual template that summarizes the learner's characteristics and enumerates the candidates, and that instructs the generative AI model to choose and justify recommended items. The server converts internal numeric features (such as high interest in science topics) into descriptive phrases (such as “prefers beginner-level science topics”).

The output is a recommendation-oriented prompt sentence in natural language ready to be input into the generative AI model.

### Step 9:

The server sends the recommendation prompt sentence to the generative AI model and receives generated recommendation information.

The input is the constructed prompt sentence and generation parameters such as maximum output length and temperature.

The server transmits the prompt sentence to the generative AI model through an API call, waits for the model to generate text, and then parses the response to extract recommended content identifiers and accompanying natural-language explanations.

The output is recommendation information that includes a selected subset of contents and textual reasons tailored to the learner.

### Step 10:

The server transmits the recommendation information to the terminal for display.

The input is the structured recommendation information including content identifiers, titles, and explanation text.

The server converts internal identifiers into full content records by querying the database, then constructs a response message including visual metadata such as thumbnail links and summaries and sends this message to the terminal over a network.

The output is a recommendation response received by the terminal that can be rendered to the user.

### Step 11:

The terminal displays the recommendation information to the user and collects interaction events.

The input is the recommendation response from the server containing content items and explanation text.

The terminal renders a recommendation section on the display, arranges items with thumbnails and titles, and shows short descriptions or reasons generated by the generative AI model. When the user selects a recommended item, scrolls through the list, or provides an explicit evaluation, the terminal logs these actions and sends corresponding interaction events to the server.

The output is a set of user interaction events that reflect the user's response to the recommendations.

### Step 12:

The server updates behavior history based on the user's interaction with the recommendations.

The input is the interaction events indicating selections, browsing duration, and evaluations for each recommended item.

The server writes new records into the behavior history table with fields such as user identifier, recommendation item identifier, operation type, and timestamp. The server may also update counters for each content and topic category to reflect increased or decreased interest.

The output is an enriched behavior history that captures fine-grained reactions to recommendation information.

### Step 13:

The server detects potential difficult information in the educational content being viewed.

The input is the current playback time and content identifier received from the terminal, along with content information including transcript text and time alignment markers.

The server retrieves the transcript segment corresponding to the current playback window, tokenizes the text, and feeds it into a difficulty classification model together with the learner profile features. The model outputs a difficulty score for the segment and highlights terms or expressions likely to be difficult. The server chooses terms whose difficulty score exceeds a threshold and marks them as difficult information.

The output is a list of difficult terms or expressions associated with positions in the transcript and with difficulty scores for the learner.

### Step 14:

The server generates an explanation prompt sentence for the generative AI model based on the detected difficult information.

The input is the list of difficult terms or expressions, the surrounding transcript context, and the learner profile including comprehension level and interests.

The server constructs a textual instruction that identifies each term, includes a short excerpt of surrounding sentences, and specifies the learner's background and preferred explanation style. The server requests a concise explanation tailored to the learner's level and indicates desired length and constraints (such as avoiding equations).

The output is an explanation-oriented prompt sentence in natural language that is ready to be sent to the generative AI model.

### Step 15:

The server sends the explanation prompt sentence to the generative AI model and obtains explanation information.

The input is the explanation prompt sentence and generation parameters tuned for short, factual responses, such as lower temperature and limited maximum length.

The server transmits the prompt sentence to the generative AI model using a network interface, receives generated text that explains the difficult terms in context, and optionally checks that the explanation is within the requested length and in the correct language.

The output is explanation information in natural language associated with each detected difficult term.

### Step 16:

The server sends the explanation information to the terminal and aligns it with the current playback.

The input is the explanation information together with term identifiers and timestamps corresponding to positions in the content.

The server packages the explanation text, the related term, and the display timing into a response message and sends it to the terminal. The server may also include display hints, such as whether to show the explanation as an overlay or in a side panel.

The output is a timed explanation response that the terminal can use to present context-aware explanations to the user.

### Step 17:

The terminal displays the explanation information during playback and records user reactions. The input is the timed explanation response from the server and the current playback time within the educational content.

The terminal compares the playback time with the timestamps in the response, displays the explanation overlay when the corresponding segment is reached, and allows the user to open, close, or expand the explanation. The terminal logs whether the user viewed the explanation, how long the explanation remained visible, and whether the user requested more details, and sends these logs back to the server.

The output is a set of explanation interaction events that reflect how the user engaged with the explanation information.

### Step 18:

The server refines the learner profile using both recommendation interactions and explanation interactions.

The input is the latest behavior history data, including reactions to recommended contents and explanations, as well as the existing learner profile.

The server updates feature values such as explanation request frequency, topic-specific completion ratios, and satisfaction indicators derived from evaluations. The server recalculates normalized features, possibly reassigns the learner to a different cluster using the clustering algorithm, and writes the updated profile back to the profile storage.

The output is a revised learner profile that more accurately represents the learner's current interests and comprehension level and that will be used as input for subsequent prompt sentence generation and model inferences.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented educational support systems typically rely on fixed rule-based engines or simple scoring logic to generate exercises and feedback for learners. Such systems often treat learning history merely as a log for display, without deeply integrating it into the computation that drives content selection and feedback generation. As a result, these systems frequently fail to adapt to fine-grained changes in a learner's understanding, cannot flexibly reorganize educational content into individualized learning courses, and provide feedback that is generic, delayed, or disconnected from the learner's actual learning trajectory.

In particular, conventional systems generally do not use server-side processors to automatically transform raw learning history data into structured analysis data, embed such analysis data into dynamically generated prompt sentences, and cooperate with a generative AI model to compute, in real time, both (i) an individualized learning course composed of educational contents arranged in an appropriate learning order, and (ii) personalized feedback that explains the learner's current status and next learning targets. As the volume and granularity of learning logs increase, traditional architectures are further limited by scalability and maintainability issues, because logic for content selection and feedback generation is hard-coded and difficult to update without redesigning the system.

Accordingly, there is a need for an improved computer-based educational support system in which a processor on a server automatically aggregates and restructures learning history into analysis data, dynamically generates prompt sentences containing such analysis data, and interacts with a generative AI model to compute, at the server, optimized learning courses and feedback outputs. By shifting key decision-making and content orchestration into a coordinated pipeline between the processor and the generative AI model, such a system can more effectively utilize learning history data, improve the quality and timeliness of feedback, and enhance the overall performance and flexibility of the computer system that provides educational support.

The specific processing by the specific processing unit 290 of the data processing device 12 in Example 2 is realized by the following means.

The present invention provides a server comprising a processor and a storage device, the processor being configured to receive learning activity data of a learner from a terminal via a communication interface and store the learning activity data in the storage device as learning history in units of individual learning records; to obtain the learning history stored in the storage device, aggregate information included in the learning history including learning targets, learning time, and evaluation results, convert the aggregated information into analysis data representing a learning status of the learner, generate a prompt sentence including the analysis data, and input the prompt sentence to a generative AI model so as to cause the generative AI model to identify learning targets that the learner has understood and learning targets with which the learner is struggling; and to extract, based on a comprehension status of the learner identified by the generative AI model, a plurality of educational contents from the storage device that stores educational contents, construct a learning course including the extracted educational contents and a learning order, generate a prompt sentence including an explanation of the learning course, progress information of the learning of the learner, and learning targets to be next learned by the learner, input the prompt sentence to the generative AI model so as to cause the generative AI model to generate feedback information including the explanation of the learning course, the progress information, and the learning targets to be next learned, and output the feedback information and the learning course to the terminal. This enables the computer system to automatically transform low-level learning logs into high-level analysis data, to compute individualized learning courses and real-time feedback in cooperation with a generative AI model, and thereby to improve the technical functioning of the educational support platform in terms of adaptivity, scalability, and effective utilization of stored learning history.

The term “system” refers to an arrangement of one or more hardware components and software components that cooperate to perform the functions described herein.

The term “server” refers to an information processing apparatus, typically including at least one processor, a storage device, a communication interface, and software modules, that provides computation, data processing, and data storage services to one or more terminals over a communication network.

The term “processor” refers to one or more hardware processing units, such as a central processing unit or a graphics processing unit, configured to execute instructions of one or more computer programs to perform data processing operations described in this specification.

The term “storage device” refers to one or more non-transitory computer-readable media, such as a magnetic storage medium, an optical storage medium, or a semiconductor memory, configured to store programs, learning history, educational contents, analysis data, and other data.

The term “terminal” refers to an information processing device operated by a learner or user, such as a personal computer, a tablet device, or a smartphone, configured to communicate with the server, present educational contents, and transmit learning activity data and answer data.

The term “learner” refers to a user who performs a learning activity using the system, including viewing educational contents, answering questions, and receiving feedback.

The term “learning activity data” refers to data indicating one or more aspects of learning behavior of a learner, including at least one of a learning target, an elapsed learning time, an access status to educational content, an answer result, or a score.

The term “learning history” refers to a collection of learning activity data stored over time for a learner, organized in units of individual learning records corresponding to specific learning sessions or events.

The term “learning record” refers to a unit of learning history representing a single learning session or event, including at least one of a learning target identifier, a time period, and one or more evaluation results such as scores.

The term “data storage device” refers to a storage device or storage subsystem that holds structured or unstructured data including at least the learning history and educational contents.

The term “educational content” refers to any digital content item used for instruction or practice, including at least one of a video, an audio file, a text document, an interactive exercise, a test item set, or a simulation.

The term “learning target” refers to an object of learning, such as a subject, a topic, a concept, or a skill, which is associated with one or more educational contents and evaluation items.

The term “evaluation result” refers to a result obtained by assessing a learning outcome of a learner, including at least one of a test score, a correctness of answers, a completion status, or a performance metric.

The term “analysis data” refers to data generated by the processor from the learning history by aggregating and transforming the learning activity data, the learning targets, the learning time, and the evaluation results into indicators representing a learning status of the learner.

The term “learning status” refers to a state of understanding or progress of a learner with respect to one or more learning targets, including at least one of a mastered level, a struggling level, or an unattempted status.

The term “prompt sentence” refers to a text string or a structured textual input that is generated by the processor and provided to a generative AI model, the prompt sentence specifying a task to be performed by the generative AI model and including at least part of the analysis data or other contextual information.

The term “generative AI model” refers to a computer-implemented model based on machine learning techniques configured to receive a prompt sentence as input and generate, as output, natural language or structured data such as an analysis result, a recommendation, or feedback information.

The term “comprehension status” refers to a condition of understanding of a learner with respect to one or more learning targets, including learning targets that have been understood and learning targets with which the learner is struggling, as identified by the generative AI model or the processor.

The term “learning course” refers to an arrangement of a plurality of educational contents, including an order or sequence for learning the educational contents, designed for the learner or a learner group based on a comprehension status or learning characteristics.

The term “learning order” refers to a sequence or schedule in which multiple educational contents are to be presented to or consumed by the learner to achieve a desired learning outcome.

The term “progress information” refers to data or a representation indicating how far the learner has advanced along a learning course or toward specific learning targets, including at least one of completion ratios, number of finished items, or recent performance trends.

The term “feedback information” refers to information generated for the learner that explains the learner's learning status, reasons for correct or incorrect answers, recommended next learning targets, or other guidance, and that is transmitted from the server to the terminal.

The term “weak field” refers to a learning target or an area in which the learner's evaluation results or analysis data indicate insufficient understanding or low performance relative to a reference level.

The term “achievement level” refers to a degree to which a learner has attained understanding or proficiency in a learning target, represented by, for example, performance scores, mastery categories, or proficiency levels.

The term “learner group” refers to a group of multiple learners classified together based on analysis data and statistical characteristics such as common weak fields, achievement levels, or learning behavior patterns.

The term “statistical method” refers to a computational technique for analyzing data, including at least one of clustering, classification, regression, or dimensionality reduction, used by the processor to classify learners into learner groups.

The term “answer data” refers to data indicating responses of the learner to one or more questions or tasks, including at least one of selected options, free-text answers, timestamps, and correctness flags.

The term “real-time feedback information” refers to feedback information generated and provided to the learner with a latency sufficiently short that the feedback corresponds to a current or immediately preceding learning interaction, such as answers just submitted.

The term “reason for an incorrect answer” refers to an explanation indicating why a learner's answer is incorrect, including a description of misconceptions, missing steps, or incorrect reasoning.

The term “supplementary explanation” refers to an additional explanation or clarification provided to reinforce or correct the learner's understanding of a learning target associated with an answer, beyond merely indicating correctness.

The term “educational content to be next presented” refers to at least one educational content item selected based on the evaluation result, the learning history, or analysis data, which is recommended or designated as the next item for the learner to study.

The term “communication interface” refers to a hardware and software component that enables data communication between the server and the terminal via a network.

The term “network” refers to a wired or wireless communication infrastructure, such as the Internet or a local area network, used to transmit data between the server and the terminal.

In one embodiment, a server cooperates with one or more terminals operated by users who act as learners. The server includes at least one processor, a main memory, a persistent storage device, and a communication interface connected to a communication network. The server executes server-side software implemented, for example, as an application on an operating system running on a general-purpose computer, a virtual machine in a cloud environment, or a dedicated appliance. The server software is implemented using a server framework such as a web application framework, an application server, and a database management system.

A terminal includes a processor, a memory, a display, an input interface, and a communication interface. The terminal executes a client application implemented, for example, as a native mobile application, a desktop application, or a web browser application. The terminal presents educational content to the user, receives user input such as answers and navigation commands, and transmits learning activity data to the server over the communication network.

The server uses a storage device, such as a relational database management system or a key-value store, to manage learning history and educational content. In one example, the server uses a relational database to store learning sessions, test results, and content metadata in structured tables. A learning history record includes a user identifier, a learning target identifier, a timestamp, a duration of the learning session, and one or more evaluation results such as test scores or correctness flags. The server organizes these records in a normalized schema to support efficient indexing and aggregation, thereby improving query performance and reducing access latency when analyzing large-scale learning data.

The server uses a generative AI model running on the same machine or on an external inference service accessed through an application programming interface. The generative AI model is implemented as a neural network, such as a transformer-based language model trained on large-scale text corpora and further fine-tuned for educational analysis tasks. In one example, the model architecture includes multiple self-attention layers, feed-forward layers, layer normalization, and positional encodings. The model parameters include weight matrices and bias vectors for each layer, which are learned by minimizing a loss function such as a cross-entropy loss or a negative log-likelihood loss during pretraining and fine-tuning. The generative AI model receives a prompt sentence as an input token sequence, processes the sequence through its attention and feed-forward layers, and outputs a token sequence representing the model's generated text.

The server converts numeric and categorical learning data into textual or structured descriptions that are embedded into a prompt sentence. The server selects features such as average score per learning target, number of attempts per learning target, recent trend of scores, time spent on each target, and distribution of correct and incorrect responses across subtopics. The server transforms these features into a representation that fits into a textual prompt, using a fixed template or a dynamically constructed narrative. Because the server uses structured feature extraction and templated prompt generation, the system reduces noise and ambiguity in the input to the generative AI model, which improves the stability and repeatability of output across different model architectures.

In one example, the server generates the following prompt sentence to request an analysis of the learner's understanding:

“You are an educational analysis assistant. Analyze the following learning history and identify: (1) learning targets the learner has mastered, (2) learning targets the learner is struggling with, and (3) recommended next learning targets. Learning history: Topic A, average score 80%, 5 attempts, last score 8/10; Topic B, average score 40%, 3 attempts, last score 3/10; Topic C, no attempts.”

In another example, the server generates the following prompt sentence to request generation of a learning course and feedback:

“You are a tutor. Based on the learner's strengths and weaknesses, construct a step-by-step learning course using the available educational contents and explain what the learner should study next. Strength: Topic A mastered. Weakness: Topic B, especially fundamental differentiation and basic integral problems. Contents: a set of beginner videos, example explanations, and quizzes for Topic B. Output: (1) an ordered list of contents as a learning course, and (2) a concise feedback message to the learner.”

The server embeds these prompt sentences into requests sent to the generative AI model and receives generated text that specifies mastered topics, weak topics, recommended sequences of content items, and feedback messages. The server parses the generated text using predetermined markers, section headers, or keyword patterns so that the output of the generative AI model is mapped to specific fields such as “mastered_topics”, “weak_topics”, “recommended_sequence”, and “feedback_message.” This structured parsing enables the server to convert free-form natural language output into machine-readable control signals that drive content selection, user interface rendering, and progress tracking, thereby integrating the generative AI model into the overall computational pipeline.

The server uses specific data structures to manage these results. For example, the server maintains, in memory, an analysis object that includes identifiers of mastered and weak learning targets, numeric confidence estimates derived from the frequencies of certain model outputs or explicit probability scores if available, and references to educational content records selected from the database. The server uses this analysis object to construct a “learning course” object, which represents an ordered list of educational content identifiers, each associated with metadata such as estimated difficulty level, prerequisite relationships, and estimated completion time. By computing learning courses at the server using these structured data flows, the system reduces redundant computation at the terminals, centralizes optimization of course generation, and permits caching of partial results across multiple learners with similar profiles. When the server groups learners into learner groups using statistical methods, such as clustering algorithms applied to feature vectors derived from learning histories, the server can generate shared learning courses per group. In this case, the server computes a feature vector for each learner, aggregates feature vectors for a group, and then generates a group-level prompt sentence that describes common weak fields and achievement levels. The server thus reduces the number of calls to the generative AI model by reusing group-level analyses and recommendations, which decreases network load and computational cost while maintaining personalization through group-level similarity.

The server uses a specific clustering algorithm in one embodiment. The server converts each learner's analysis data into a high-dimensional feature vector, where each dimension corresponds to a normalized score or activity metric for a learning target or subtarget. The server applies a clustering technique, such as k-means clustering or hierarchical clustering, to partition learners into groups whose feature vectors are similar in terms of Euclidean distance or cosine similarity. The server then generates a prompt sentence that describes each group as a profile with shared weaknesses and strengths, and requests from the generative AI model a group-optimized learning course. This use of statistical grouping reduces the complexity of individual course computation and yields a technical effect of improved scalability when the number of learners is large. The server also performs low-level optimizations to improve computational efficiency. For example, the server precomputes aggregation statistics for learning histories in batch processes, storing these intermediate statistics in the storage device so that online requests can reuse them. The server maintains indices on fields such as learner identifier, learning target identifier, and timestamp, which permit efficient range queries and reduce the time required to assemble input data for the generative AI model. Because the server avoids repeatedly scanning raw logs and instead uses summarized analysis data, the overall processing time and storage input/output load are reduced, which is a concrete improvement to computer performance beyond mere automation of human teaching tasks.

The generative AI model operates in conjunction with a specialized prompt structure. The server implements rule-based prompt composition strategies that ensure consistent placement of metadata, delimiters, and instructions within the prompt sentence. For instance, the server always places instructions at the beginning of the prompt, followed by a delimited block of learning history and a separate block listing available content identifiers. The server detects and corrects malformed or incomplete responses by re-sending a shorter corrective prompt, and logs all model interactions for control and auditing. This controlled interaction pattern reduces variance in model outputs and improves determinism, which is critical for a computing system that must provide stable recommendations over time.

In connection with answer evaluation, the server receives answer data from the terminal as structured data. The server computes evaluation results using algorithms that compare user answers to solution keys, scoring rubric rules, or probabilistic models of partial correctness. The server then generates a prompt sentence that includes not only the correctness of each answer, but also the question type, difficulty tag, and, where available, specific conceptual tags. The server uses these tags to ask the generative AI model for explanations targeted to particular concepts, which improves the specificity of feedback.

In one example, the server generates the following prompt sentence to obtain immediate feedback for a single answer:

“You are a tutor. A learner answered the following question incorrectly. Question: Differentiate f(x)=3x\hat{ }2. Learner's answer: f′(x)=3x. Correct answer: f′(x)=6x. Explain briefly why the answer is incorrect and what rule the learner should review. Then recommend one appropriate basic exercise on differentiation of polynomials.”

The server does not simply forward raw logs to the model. Instead, the server preprocesses the data to ensure that each prompt is compact, standardized, and machine-friendly. This preprocessing reduces token count and network payload to the generative AI model, thereby lowering latency and resource consumption. This technical effect is significant in large-scale deployments where many learners request feedback simultaneously.

The generative AI model is trained or fine-tuned on educational dialogues and structured task descriptions. The training procedure uses gradient-based optimization such as stochastic gradient descent or its variants. During training, the model parameters are updated to minimize a loss function that penalizes incorrect or unhelpful responses. The model is also optionally aligned using reinforcement learning from human feedback, in which human evaluators score candidate responses and a reward model is trained to approximate those scores. The final generative AI model used in the system is thus configured to produce reliable, concise, and pedagogically appropriate outputs when given prompt sentences that follow the structure defined by the server. The server operates in a manner that improves computer efficiency compared to naive designs. Because the server generates and reuses analysis data and group-level recommendations, the number of full retraining or re-analysis operations is reduced. The server also caches commonly requested learning courses and feedback templates keyed by learner profiles. When a new learner's profile closely matches an existing profile, the server retrieves cached results rather than invoking the generative AI model for a full analysis. This caching mechanism decreases computational load on the model infrastructure and shortens response time to the terminal, which is a tangible improvement in system responsiveness.

The terminal displays feedback and learning course information using graphical user interface components. The terminal receives, from the server, a structured representation of the learning course and feedback message. The terminal maps each educational content identifier to interactive elements such as buttons or list entries, and presents the feedback message in a text area. Because the server has already determined the learning order and associated metadata, the terminal performs minimal computation before rendering, which reduces power consumption and processing load on the terminal device.

The server in this system does not merely automate what a human tutor would do. The server uses algorithmic transformations and data structures that are impractical to execute manually, such as large-scale statistical clustering of thousands or millions of learners into groups, continuous aggregation of high-volume learning logs, and iterative refinement of learning courses based on fine-grained behavioral metrics. The generative AI model interacts with this computational framework through well-defined prompt sentences that carry structured, machine-generated analysis data. As a result, the system provides a new technical capability: namely, the real-time and large-scale orchestration of learner-specific or group-specific educational content and feedback, with reduced latency and improved throughput relative to traditional systems. In an alternative embodiment, the server uses a different type of generative AI model, such as a sequence-to-sequence model with encoder-decoder architecture, or a recurrent neural network with attention mechanisms. In another embodiment, the feature extraction process produces numerical feature vectors that are passed to a separate neural network classifier or regressor to compute mastery levels, while the text-generating generative AI model is used primarily to formulate human-readable feedback messages. In yet another embodiment, the server uses supervised learning models, such as gradient-boosted decision trees, to predict the probability that a learner will answer a future question correctly, and uses this probability as an additional feature when forming prompt sentences for the generative AI model.

The server may also apply data augmentation and noise reduction strategies. For example, when the server detects irregular learning sessions or outlier scores, the server flags such records and adjusts their weight in the aggregation process. The server may synthesize smoothed performance curves using sliding windows or exponential moving averages to avoid overreacting to isolated anomalies. These techniques reduce the variance of analysis data and yield more stable prompt inputs to the generative AI model, contributing to consistent and accurate feedback and recommendations.

In all of these embodiments, the server continuously records logs of internal operations, including the content of prompt sentences, model responses, and important decision points in the analysis pipeline. These logs enable debugging, evaluation of model performance, and iterative improvement of prompt structures and feature extraction methods. The explicit design of the data flow, control flow, and prompt sentence composition, together with the use of specific AI model architectures and feature-based algorithms, ensures that the system constitutes a concrete improvement to the functioning of the computer-based educational support platform rather than merely implementing an abstract instructional method.

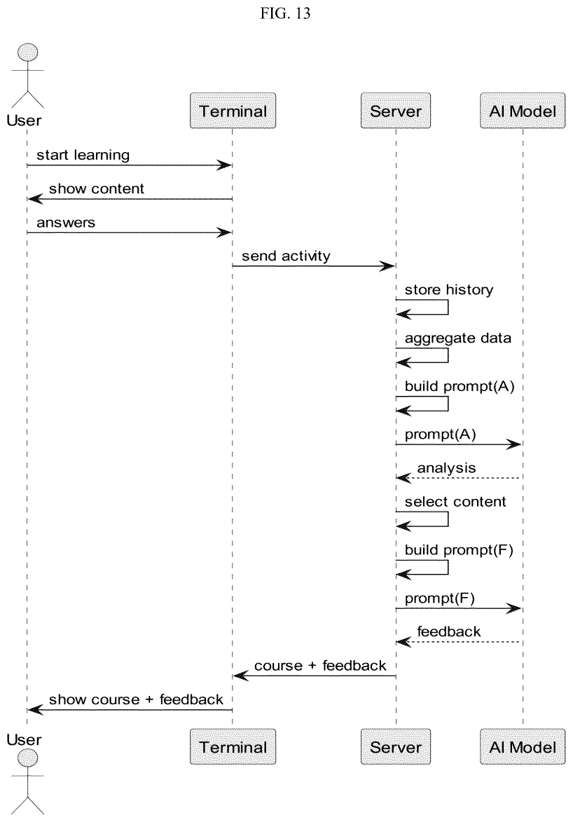

The following describes the processing flow using FIG. 13.

### Step 1:

The user operates the terminal to perform a learning activity.

The user selects a learning target on the terminal, views educational content such as a video or an interactive exercise, and answers questions presented by the terminal.

The terminal receives user interactions as input, including content selection, start and end times of viewing, answer choices, typed text answers, and navigation actions.

The terminal processes these inputs by time-stamping events, associating them with content identifiers and learning target identifiers, and computing basic metrics such as elapsed time per content item.

The terminal outputs structured learning activity data, including for example: learner ID, content ID, learning target ID, start time, end time, and raw answer data for each question.

### Step 2:

The terminal transmits learning activity data to the server.

The terminal takes the structured learning activity data as input and serializes it into a message format suitable for network transmission, such as a JSON object carried in an HTTPS request. The terminal performs data validation for required fields (for example, learner ID and content ID), encrypts the communication channel, and sends the message to a designated server endpoint.

The terminal receives an acknowledgment or error response from the server and, based on the output, marks each local activity record as successfully uploaded or pending retry.

### Step 3:

The server receives and stores learning activity data as learning history.

The server accepts the serialized learning activity data from the terminal as input through a communication interface.

The server parses the received data, verifies authentication tokens, and validates the data schema.

The server performs data processing by mapping the received fields to internal data structures, normalizing identifiers, and converting timestamps to a unified format.

The server then writes the processed data into a storage device as learning history records, using database insert operations that populate tables such as learning_sessions and answer_logs.

The server outputs a storage confirmation, and may output a generated record identifier to the terminal as part of the acknowledgment.

### Step 4:

The server aggregates learning history into analysis data.

The server uses the stored learning history records as input, selected for a specific learner or group of learners based on query parameters such as learner ID or time range.

The server executes aggregation operations, including grouping records by learning target, computing average scores, counting attempts, summing learning time, and calculating score trends using moving averages or recent-window statistics.

The server applies normalization functions to scale scores and time values into comparable ranges and optionally computes feature vectors where each dimension represents a metric for a particular learning target.

The server outputs analysis data that includes, for each learning target, values such as average score, number of attempts, total time, recent score trend, and a compact feature representation.

### Step 5:

The server generates a prompt sentence for analysis by a generative AI model.

The server takes the analysis data as input, including per-target metrics and any predefined thresholds for mastery and weakness.

The server performs data transformation from structured numeric form into a textual description by embedding the metrics into a predesigned template.

The server composes a prompt sentence that instructs the generative AI model to categorize learning targets and to recommend next steps, appending a formatted list of targets and their associated statistics.

The server outputs a complete prompt sentence such as:

“You are an educational analysis assistant. Analyze the following learning history and identify: (1) learning targets the learner has mastered, (2) learning targets the learner is struggling with, and (3) recommended next learning targets. Learning history: Target A, average score 80%, attempts 5, last score 8/10; Target B, average score 40%, attempts 3, last score 3/10; Target C, no attempts.”

### Step 6:

The server sends the prompt sentence to the generative AI model and obtains an analysis result.

The server uses the generated prompt sentence as input to the generative AI model by packaging it into a request to an inference service.

The server calls the generative AI model via an application programming interface, specifying model name and inference parameters such as temperature and maximum output length.

The generative AI model processes the prompt and returns a generated text response to the server.

The server receives this text response as output and may temporarily store it in memory or in a log for further processing.

### Step 7:

The server parses the generative AI model's analysis output into structured form.

The server takes the generated text from the generative AI model as input.

The server applies parsing rules based on expected section headers, keywords, or delimiters, and extracts elements such as lists of mastered learning targets, weak learning targets, and recommended next targets.

The server maps textual names of targets to internal identifiers by looking up corresponding entries in a content or target registry.

The server outputs a structured analysis object that includes fields for mastered_targets, weak_targets, and recommended_targets, each represented as sets of identifiers and, optionally, associated confidence indicators.

### Step 8:

The server selects educational content and constructs a learning course.

The server uses the structured analysis object as input, especially the identified weak and recommended targets.

The server queries a content storage subsystem for educational content items tagged with relevant learning targets, difficulty levels, and prerequisite relations.

The server performs content selection by filtering for content items that match the weak or recommended targets and then applies ordering logic based on prerequisite graphs, estimated difficulty, and expected time to complete.

The server constructs a learning course as an ordered list of content identifiers, each annotated with learning target, level, and suggested position in the sequence.

The server outputs a learning course object ready for presentation to the learner.

### Step 9:

The server generates a prompt sentence for feedback and course explanation.

The server takes as input both the structured analysis object and the constructed learning course.

The server composes a new prompt sentence that instructs the generative AI model to generate a human-readable explanation of the learner's current status and the learning course.

The server embeds information such as strengths, weaknesses, and the list of selected content, and may specify constraints such as word length and tone.

The server outputs a complete prompt sentence, for example:

“You are a tutor. Based on the learner's strengths and weaknesses, construct a step-by-step explanation of the following learning course and tell the learner what to study next. Strength: Topic A mastered. Weakness: Topic B, especially fundamental differentiation. Learning course: (1) Topic B basic video, (2) Topic B worked examples, (3) Topic B quiz. Output: a concise feedback message explaining progress and next steps.”

### Step 10:

The server sends the feedback prompt sentence to the generative AI model and obtains feedback text.

The server uses the feedback-oriented prompt sentence as input to the generative AI model through the same or a similar inference interface.

The server triggers inference, waits for the model to generate text, and receives the model's output containing a feedback message aligned with the specified learning course.

The server optionally performs post-processing, such as trimming excess text, checking for required segments, and sanitizing any unwanted content.

The server outputs finalized feedback text that explicitly references the learner's mastered topics, weak topics, and recommended next content items.

### Step 11:

The server packages and transmits the learning course and feedback to the terminal.

The server uses as input the learning course object and the finalized feedback text.

The server formats these into a response structure that includes ordered content identifiers, display titles, links or resource locators for each content item, and the textual feedback message.

The server sends this response to the terminal via the communication interface, using a defined application protocol and message schema.

The server outputs a successful response status, indicating that the new course and feedback are ready to be consumed by the terminal.

### Step 12:

The terminal displays the learning course and feedback and accepts further user actions.

The terminal takes the course information and feedback message from the server's response as input.

The terminal maps each content identifier to user interface elements such as buttons or list entries, arranges them according to the learning order, and renders the feedback message as readable text near the course list.

The terminal updates its local state to reflect the new recommended course and prepares links or controls for the user to start each recommended content item.

The terminal outputs a visual and interactive representation of the learning course and feedback on the display.

### Step 13:

The user adjusts learning behavior based on feedback and new recommendations.

The user reads the feedback message displayed on the terminal as input and observes which learning targets are identified as strong or weak.

The user selects one of the recommended content items, such as a basic review video or a focused practice quiz, and begins a new learning session through the terminal interface.

The user's actions generate new learning activity data, including updated scores and time-on-task measurements.

The user thereby outputs new learning behavior that, when transmitted to the server, becomes input for the next cycle of aggregation, analysis, course construction, and feedback generation.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented learning support systems typically rely on static rules or pre-authored content selection logic executed by a processor. Such systems analyze only coarse learning history data, such as past scores or completed lessons, and then select pre-defined problems or materials based on fixed thresholds. As a result, the systems provide limited adaptability and cannot leverage the full expressive power of modern generative AI models. In particular, these systems do not systematically construct machine-readable and machine-controllable prompt sentences that encode, in a unified way, (i) detailed comprehension analysis, (ii) real-time behavioral and emotional states, and (iii) dynamic course progression policies. Consequently, the processor's ability to control the generative AI model as a configurable computational resource is significantly underutilized.

Furthermore, existing systems generally treat feedback generation and course adaptation as isolated post-processing steps that are hard-coded in application logic. They do not treat the generation of feedback, additional content, and course restructuring as a single, integrated inference loop driven by structured prompt sentences. This leads to fragmented data flows, duplicated computations, and inefficient use of processing resources and memory. The processor often re-runs similar analyses or queries, and cannot efficiently update future content generation parameters based on prior model outputs and updated user state.

Moreover, most systems either ignore emotion signals altogether or process them in a separate module that is not tightly coupled to the learning-content generation pipeline. Even when facial or voice information is collected, it is rarely combined, in real time, with comprehension analysis results to modify the control inputs to a generative AI model. As a result, the system cannot dynamically tune the difficulty and pacing of generated content as a function of both knowledge state and emotional state. This limitation reduces the effectiveness of personalization and fails to exploit emotion signals as a first-class control parameter for the content-generation computation. Therefore, there is a need for an improved computer-implemented system in which a processor (i) analyzes learning history using statistical or machine-learning techniques, (ii) estimates emotional state from multimodal inputs, (iii) merges these analyses into structured prompt sentences supplied to a generative AI model, and (iv) dynamically updates an internal representation of the learning course. By architecting this as a closed computational loop between the processor, the storage device, and the generative AI model, it becomes possible to improve the way the computer allocates processing resources, manages data structures, and controls the generative AI model, thereby enhancing the technical performance of the adaptive learning platform itself.

The specific processing by the specific processing unit 290 of the data processing device 12 in Application Example 2 is realized by the following means.

The present invention provides a server comprising a processor and a storage device configured so that the processor acquires learning history information of a learning subject from the storage device, analyzes a comprehension level and weakness areas of the learning subject using statistical analysis or a machine learning algorithm, generates, in memory, a structured representation of conditions including an analysis result of the comprehension level, an emotional state estimated from facial information or voice information of the learning subject, and a type and difficulty level of learning content to be output, transforms the structured representation into a prompt sentence, and supplies the prompt sentence as a control input to a generative AI model to cause the generative AI model to generate learning materials or questions; the processor further evaluates answer information and operation history information of the learning subject received from a terminal device by determining correctness and required time of the answer information, generates, based on an evaluation result and the emotional state, another prompt sentence that instructs generation of feedback information or additional learning content, inputs the another prompt sentence to the generative AI model, and transmits an output result of the generative AI model to the terminal device; and the processor additionally generates, and persistently maintains in the storage device, learning course information in which a progression order and difficulty level of learning topics are dynamically updated for each learning subject based on the evaluation result and the emotional state, and automatically adjusts contents of subsequent prompt sentences in accordance with the learning course information so that subsequent invocations of the generative AI model are parameterized by the updated learning course information. This enables the computer system to implement a closed-loop control architecture in which the processor uses unified prompt sentences as programmable control signals for the generative AI model, thereby improving computational efficiency, reducing redundant analysis, dynamically reallocating processing and storage resources, and enhancing the responsiveness and precision of adaptive content generation at the system level.

The term “learning subject” refers to an individual who interacts with the system to acquire knowledge or skills and whose learning history, answers, and behavioral information are processed by the processor.

The term “learning history information” refers to data representing past learning activities of the learning subject, including at least problem identifiers, correctness of answers, timestamps, time spent, accessed materials, and completion status of learning tasks.

The term “comprehension level” refers to a measure, computed by the processor, of how well the learning subject has understood one or more learning topics, the measure being derivable from the learning history information using statistical analysis or a machine learning algorithm.

The term “weakness areas” refers to one or more learning topics or concept categories identified by the processor as being insufficiently mastered by the learning subject in comparison with other topics or with predefined criteria.

The term “statistical analysis” refers to computational processing that applies statistical techniques, such as aggregation, normalization, or regression, to numerical or categorical data included in the learning history information.

The term “machine learning algorithm” refers to a computational method executed by the processor that learns patterns or models from data, such as supervised learning, unsupervised learning, or reinforcement learning, and outputs predictions or classifications related to the comprehension level or learning tendencies of the learning subject.

The term “emotional state” refers to a psychological condition of the learning subject, such as confusion, fatigue, excitement, or joy, estimated by the processor on the basis of sensor data including facial information or voice information.

The term “facial information” refers to data representing the face of the learning subject, including image data, facial landmarks, expression features, or other visual attributes captured by an image acquisition device.

The term “voice information” refers to audio data representing the voice of the learning subject, including waveform data, pitch, intensity, speaking rate, or other acoustic features captured by a sound acquisition device.

The term “learning content” refers to information generated or selected by the system for presentation to the learning subject, including at least learning materials, explanations, questions, practice tasks, and course guidance.

The term “learning materials” refers to instructional content such as text, diagrams, examples, code snippets, or other representations designed to explain concepts or procedures to the learning subject.

The term “questions” refers to problem statements or prompts that require a response from the learning subject, including multiple-choice items, open-ended questions, numerical problems, or programming tasks.

The term “generative AI model” refers to a computational model that receives a prompt sentence as input and outputs generated content, the model being configured to produce natural language text and optionally other structured data representing learning content or feedback.

The term “prompt sentence” refers to a sequence of machine-readable instructions expressed in natural language or a structured representation, generated by the processor, and supplied as input to the generative AI model to control the type, difficulty, and content of the model's output. The term “answer information” refers to data representing responses provided by the learning subject to questions generated or presented by the system, including the content of the responses and associated metadata such as timestamps.

The term “operation history information” refers to interaction data generated by the learning subject while using a terminal device, including navigation actions, time spent on screens, use of hints, or other user interface events that are captured and transmitted to the server.

The term “feedback information” refers to content generated or selected by the system and presented to the learning subject in response to answer information and evaluation results, including correctness indications, explanations, hints, recommendations, and encouragement messages.

The term “additional learning content” refers to learning content generated after an initial interaction, intended to further support the learning subject, and including follow-up questions, supplementary explanations, or review materials.

The term “learning course information” refers to structured data representing a plan or sequence of learning topics, difficulty levels, and associated content items for the learning subject, the plan being dynamically updated by the processor.

The term “progression order of learning topics” refers to a defined sequence or ordering of subject areas, modules, or concepts that the learning subject is intended to study, as maintained and adjusted in the learning course information.

The term “difficulty level of learning topics” refers to an indication of the relative complexity or challenge associated with a topic or content item, such as beginner, intermediate, or advanced, determined and updated by the processor.

The term “learning group” refers to a subset of a plurality of learning subjects that share similar comprehension levels or learning tendencies, as determined by the processor using unsupervised learning processing including clustering.

The term “learning tendencies” refers to patterns in how a learning subject or a learning group interacts with content over time, such as preferred pacing, typical error patterns, or responsiveness to difficulty adjustments, derived from learning history information.

The term “unsupervised learning processing” refers to machine learning processing that identifies structures, clusters, or patterns in data without using explicit labeled target values, and that is executed by the processor on learning history information.

The term “clustering” refers to an unsupervised learning technique in which the processor groups data points, such as learning subjects or learning sessions, into clusters based on similarity metrics, thereby forming learning groups.

The term “terminal device” refers to an information processing apparatus operated by the learning subject, such as a computing device with a user interface, that transmits input information to the server and receives and displays learning content and feedback information.

The term “storage device” refers to a memory component or combination of memory components, local or remote, used to store learning history information, learning course information, generative AI outputs, and control parameters for execution by the processor.

The term “server” refers to a computing apparatus comprising at least the processor and the storage device, configured to communicate with one or more terminal devices over a communication network to perform analysis, generation, and control operations as recited in the claims.

The term “output result of the generative AI model” refers to data generated by the generative AI model in response to a prompt sentence, including text, structured content, or other information that can be transformed into learning materials, questions, or feedback information.

The term “subsequent prompt sentences” refers to prompt sentences generated by the processor after previous interactions have been evaluated, the subsequent prompt sentences being adjusted in accordance with updated learning course information and emotional state.

The term “closed-loop control architecture” refers to a computational structure in which outputs of the generative AI model and updated evaluation and emotion analysis results are fed back as inputs to the processor for generation of subsequent prompt sentences and updated learning course information.

In one embodiment, a server implements the claimed system by executing program modules on one or more processors and cooperating with one or more terminal devices operated by a user. The server comprises at least a central processing unit, a main memory, a non-volatile storage device, and a network interface. The storage device stores a learning history database, a model-parameter repository, a content cache, and executable program instructions. The server executes an operating system and application software developed, for example, in a high-level language such as Python and JavaScript. The server optionally uses established software libraries, such as a numerical computation library, a data analysis library corresponding to pandas, and a machine learning library corresponding to scikit-learn, as well as a deep-learning framework corresponding to TensorFlow or PyTorch, to implement the described processing. The terminal is, for example, a smartphone, a tablet computer, or a personal computer including at least a processor, a memory, a display, an input device, an image sensor, and a sound sensor. The terminal executes an application that may be implemented using a cross-platform framework corresponding to React Native or a web browser application. The terminal communicates with the server through a communication network using a protocol such as HTTPS. The user operates the terminal, views learning content, and inputs responses through a graphical user interface.

The server stores, in the storage device, learning history information as records in a relational schema. Each record may include fields such as: learner identifier, topic identifier, problem identifier, timestamp, answer correctness, time-to-answer, hint usage count, and emotional-state tags. By storing structured learning history in this way, the server can perform efficient indexed queries and aggregations that would not be feasible with unstructured logs. The server also stores learning course information as structured data, for example as a table or document containing, for each learner identifier, an ordered list of topic identifiers, a difficulty-level parameter for each topic, and a state flag indicating completion status.

The server executes a comprehension-analysis module that treats the learning history information as input data and computes a comprehension level and weakness areas. The server uses a data analysis library to transform raw records into a matrix representation in which each row corresponds to a topic or sub-topic and each column corresponds to a feature, such as average accuracy, average time-to-answer, problem difficulty index, and recency-weighted score. The server normalizes these features, applies optional dimensionality reduction, and then applies a machine learning algorithm such as clustering, logistic regression, or gradient boosting to assign comprehension scores to each topic. The server may use an unsupervised clustering algorithm, such as k-means or hierarchical clustering, to form learning groups over multiple learners, and may use supervised algorithms to predict expected success rate for upcoming topics. The server further executes an emotion-analysis module. The terminal acquires facial information using the image sensor and voice information using the sound sensor and transmits these data to the server. The server may pre-process this data or may receive pre-processed features computed on the terminal using an image-processing library corresponding to OpenCV or a speech-processing library. In one embodiment, the server uses a convolutional neural network to process facial images. The neural network may comprise multiple convolutional layers, pooling layers, and fully-connected layers, trained with a cross-entropy loss to classify emotions such as confusion, fatigue, excitement, and joy. The server also uses a recurrent or transformer-based neural network to process acoustic features extracted from voice information, such as pitch, energy, and spectral coefficients. The server fuses outputs of these models, for example by concatenating feature vectors and passing them through a fully-connected layer, to obtain an emotional state label and confidence score.

The server stores the emotional state label in association with a timestamp and learning context (current topic and problem identifier). By associating emotional states with learning history, the server creates a data structure that can be used to correlate comprehension and emotion and to adjust future content generation. This integrated data structure improves data locality and reduces redundant retrievals because the server can access comprehension and emotion information from a unified record rather than performing separate queries.

The server implements a prompt-construction module that generates a prompt sentence as a structured natural-language instruction for a generative AI model. The server receives, from the comprehension-analysis module, a per-topic comprehension level and weakness areas, and receives, from the emotion-analysis module, the current emotional state. The server also reads the current learning course information, which specifies the progression order and difficulty policy. The server encodes these values into a structured intermediate representation, for example a key-value map containing entries such as: target_topic, target_difficulty, learner_level, emotional_state, output_type, and number_of_problems.

The server then transforms this intermediate representation into a human-readable but machine-constructible prompt sentence. For example, the server may generate:

“The learner is a beginner in calculus and struggles with basic derivatives. The learner currently appears confused. Generate three very simple derivative problems with detailed, step-by-step explanations.”

In another example related to programming, the server may generate:

“The learner has an intermediate understanding of Python data types and has just completed a tutorial successfully. Generate a medium-level tutorial on Python conditional statements with five practice tasks.”

The server sends the prompt sentence to a generative AI model. In one embodiment, the generative AI model is a large language model implemented as a transformer neural network, trained on a corpus including educational texts and problem sets. The model may have multiple attention layers, feed-forward layers, layer-normalization components, and learned embeddings.

The model uses a training procedure such as stochastic gradient descent or an adaptive optimizer, with a loss function measuring next-token prediction or instruction-following accuracy. By training the model in advance in this manner, the server can treat the model as a parameterized text generator whose behavior is controlled through the prompt sentence.

The server supplies the prompt sentence and generation parameters, such as maximum token length, sampling temperature, and top-k or top-p constraints, to the generative AI model through an application programming interface. The model returns generated text representing learning materials, questions, or feedback content. The server parses the generated text according to simple rules or templates, such as identifying sections beginning with “Question” or “Explanation,” and converts the text into structured content objects containing problem statements, solution keys, and explanation segments.

The server evaluates answer information and operation history information received from the terminal. The terminal displays generated learning content to the user and records user interactions, including answers, hint requests, navigation between screens, and times spent. The terminal transmits answer information and operation history information to the server in a defined message format. The server compares answer information with correct answer keys contained in the structured content objects. If an answer is open-ended, the server may additionally construct a grading prompt sentence such as:

“The learner's answer to the following derivative problem may contain minor mistakes. Evaluate whether the answer is essentially correct and provide a brief explanation.”

The server sends this grading prompt sentence to the generative AI model and receives a structured evaluation, such as correct, partially correct, or incorrect. The server aggregates correctness results, time-to-answer, and hint usage into updated comprehension scores and stores these scores in the learning history information.

The server next constructs another prompt sentence for feedback and follow-up content. For example, if the learner answered incorrectly and the emotional state is confusion, the server may generate:

“The learner answered the following derivative problem incorrectly and appears confused.

Provide a clear, step-by-step explanation and one simpler follow-up exercise.”

If the learner answered correctly and appears excited, the server may generate:

“The learner solved this intermediate Python conditional question correctly and seems confident.

Provide a short congratulatory message and one slightly harder challenge question.”

The server sends the feedback prompt sentence to the generative AI model and receives feedback information and, optionally, additional learning content. The server then transmits this information to the terminal, which displays explanations, encouragement, and new exercises.

The server maintains and updates learning course information in the storage device. The server periodically merges new evaluation data and emotional-state data into the learning course information. For each learner, the server may store a progression graph of topics, including edges representing feasible transitions and weights representing recommended difficulty increments. The server uses a decision algorithm, such as a rules-based engine or a reinforcement-learning agent, to select the next topic and difficulty level. The decision algorithm may incorporate thresholds on comprehension scores, stability measures of emotional state, and recent performance trends. By explicitly modeling topic transitions and decisions, the server can compute next-step recommendations efficiently, without scanning the entire historical record each time.

The server uses the updated learning course information to adjust contents of subsequent prompt sentences. For instance, when the learning course information indicates repeated difficulties in a given topic and repeated negative emotional states, the server modifies the intermediate representation so that the output_type is set to “review,” the target_difficulty is decreased, and the number_of_problems parameter is limited. The server may then generate a prompt sentence such as:

“The learner has repeatedly made mistakes on chain rule problems and appears discouraged.

Generate three review problems on basic derivatives with highly detailed explanations and encouraging language.”

This direct feedback loop between stored learning course information and prompt construction improves technical performance by eliminating repeated, redundant computations and by enabling the server to construct prompt sentences in constant or logarithmic time with respect to the number of historical records.

The server's modules are implemented as separate components that share data structures via defined interfaces. For example, the comprehension-analysis module writes comprehension vectors into a memory-resident cache, the emotion-analysis module writes emotional-state labels into the same cache, and the prompt-construction module reads both types of data from the cache. This modular structure reduces input/output operations to long-term storage and minimizes latency, which directly improves responsiveness when generating new content. In an alternative embodiment, the server deploys a generative AI model locally using a deep-learning framework. The server loads the model parameters into GPU memory and uses batched prompt processing so that multiple learners' prompt sentences are processed together in a single batch. This batched processing increases throughput and reduces average response time per learner. The server also may quantize model parameters or use mixed-precision arithmetic to reduce memory bandwidth and accelerate matrix multiplications, thus improving computational efficiency.

In another embodiment, the terminal performs part of the emotion analysis. The terminal executes an image-processing library to detect a face region and compute a feature vector representing facial expressions. The terminal transmits only the feature vector rather than the raw image data to the server. This reduces communication bandwidth usage and improves privacy. The server then feeds the feature vector into a smaller neural network to classify the emotional state. This division of labor between terminal and server reduces overall latency and network load, thereby enhancing real-time responsiveness of the system.

The described system improves computer technology in several ways. First, by encoding comprehension, emotion, and course policy into unified prompt sentences, the server treats the generative AI model as a programmable co-processor whose behavior is controlled through precisely defined inputs. This structured control reduces the need for ad hoc rule-based post-processing and leads to more predictable and efficient use of the generative model. Second, by storing and updating learning course information as a persistent, structured data object, the server avoids recomputing course decisions from raw logs and thereby achieves faster decision-making and reduced processing load. Third, by integrating emotion analysis with comprehension analysis at the data-structure level, the server enables prompt sentences that adapt difficulty and pacing automatically, which reduces the number of iterations required to reach a target comprehension level.

In addition, the server applies machine learning algorithms, such as clustering and neural networks, in ways that are not equivalent to manual human judgment. The server operates on high-dimensional feature vectors, continuously updates model parameters during training phases, and uses loss functions and gradient-based optimization to refine decision boundaries. These computational procedures are not merely automated replication of human grading or tutoring, but constitute specific algorithmic improvements that allow the system to scale to large numbers of learners and to respond in near real time under constrained computing resources.

In a further embodiment, the server applies a reinforcement-learning algorithm to adjust parameters used in prompt generation, such as difficulty and content length. The server defines a reward function that increases when learners achieve correct answers with moderate effort and stable or positive emotional states. By updating policy parameters based on this reward function, the server learns non-intuitive strategies for pacing and scaffolding that are optimized for computational performance and learner outcomes. This adaptive optimization further reduces unnecessary content generation and network traffic, thus improving efficiency.

The user interacts with the system only through the terminal interface. The user does not need to manage data structures, model parameters, or prompt sentences. The server executes all such operations internally, thereby providing a technically improved adaptive learning platform in which the generative AI model is tightly controlled by structured prompt sentences derived from machine-learning and emotion-analysis computations.

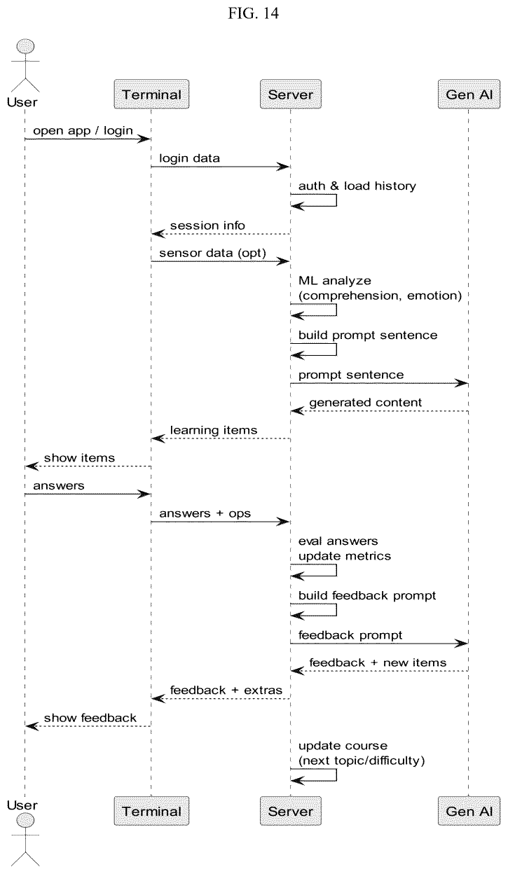

The following describes the processing flow using FIG. 14.

### Step 1:

Server authenticates the user and initializes session data.

Server receives, as input, login credentials and device information transmitted from the terminal.

Server validates the credentials using an authentication module and queries a storage device to obtain a user profile and existing learning course information. Server performs data processing by executing an SQL query to fetch profile records, parsing the result set into in-memory objects, and associating these objects with a newly created session identifier. As output, server generates a session token, an initial learning context (current topic, level), and a reference to the user's learning history, and sends the session token and basic profile data back to the terminal.

### Step 2:

Server acquires learning history information and builds feature vectors.

Server receives, as input, the user identifier and optional filter parameters (such as subject or time range) from the session context. Server accesses the learning history table in the storage device and retrieves records including problem identifiers, correctness flags, timestamps, time-to-answer, and hint usage counts. Server performs data processing by aggregating these records by topic, computing statistical values such as average accuracy, mean and variance of time-to-answer, and recency-weighted scores, and assembling them into a numerical feature vector per topic. As output, server produces a topic-feature matrix representing the user's historical performance and stores this matrix temporarily in main memory for subsequent analysis.

### Step 3:

Server analyzes comprehension level and weakness areas using machine learning.

Server receives, as input, the topic-feature matrix generated in Step 2. Server executes a machine learning algorithm, such as clustering or regression, to infer comprehension scores. For example, server normalizes each feature dimension, applies a clustering algorithm to group feature vectors, and assigns a comprehension label (e.g., low, medium, high) based on cluster centroids. Server then identifies weakness areas by selecting topics whose comprehension scores fall below a predefined threshold or whose error rates exceed a model-predicted baseline. As output, server generates a structured data object containing per-topic comprehension levels and a list of weakness topics, and updates this object in the user's learning state record.

### Step 4:

Terminal captures facial information and voice information and transmits emotion-related data. Terminal receives, as input, a control signal or configuration from the server indicating that emotion analysis is enabled for the current session. Terminal activates an image sensor and a sound sensor, captures image frames of the user's face and audio segments of the user's voice, and optionally pre-processes these raw signals to extract basic features such as face bounding boxes or spectrograms. Terminal performs data processing by compressing the captured data, encoding it into a defined format (for example, feature vectors or lightweight image frames), and associating timestamps and context identifiers. As output, terminal transmits the emotion-related data to the server as part of a sensor-data message.

### Step 5:

Server estimates an emotional state from multimodal input.

Server receives, as input, the emotion-related data from the terminal, including facial information and voice information or derived features. Server feeds image data into a convolutional neural network and audio-derived features into a recurrent or transformer-based neural network. Server performs data processing by executing forward passes through these networks, obtaining probability distributions over emotion categories (such as confusion, fatigue, excitement, and joy), and fusing these distributions by concatenating feature vectors and applying a classifier layer. As output, server determines an emotional state label and confidence score for the current time window, stores this emotional-state record in association with the learning context, and makes the label available to subsequent modules.

### Step 6:

Server constructs an intermediate representation for prompt generation.

Server receives, as input, the comprehension analysis result from Step 3, the emotional state from Step 5, and the current learning course information from the storage device. Server executes data processing by selecting a target topic based on weakness areas or progression rules, determining a difficulty parameter (e.g., easier for low comprehension and negative emotion, harder for high comprehension and positive emotion), and choosing an output type such as “review problems,” “tutorial explanation,” or “challenge questions.” Server assembles these decisions into an internal structured object containing entries like target_topic, learner_level, emotional_state, output_type, and num_items. As output, server provides this structured intermediate representation to a prompt-construction module.

### Step 7:

Server generates a prompt sentence for a generative AI model.

Server receives, as input, the structured intermediate representation from Step 6. Server performs data processing by mapping internal fields to natural-language phrases, ordering them according to a predefined template, and concatenating them into a coherent instruction. For example, server may produce a prompt sentence such as: “The learner is a beginner in calculus and struggles with basic derivatives. The learner currently appears confused. Generate three very simple derivative problems with detailed, step-by-step explanations.” As output, server obtains a fully formed prompt sentence that encodes comprehension, emotion, and desired content properties, and forwards this prompt sentence to a generative AI model interface.

### Step 8:

Server requests content generation from the generative AI model.

Server receives, as input, the prompt sentence from Step 7 and generation parameters such as maximum token count, sampling temperature, and diversity constraints. Server calls an interface to a generative AI model, which may be a transformer-based neural network pre-trained for text generation. Server performs data processing by encapsulating the prompt sentence and parameters into an API request, sending it to the model runtime, and waiting for a generated text response. As output, server receives generated content in text form, which may include problem statements, explanations, and structured headings, and stores this generated content temporarily in a content cache along with metadata linking it to the session and user.

### Step 9:

Server parses generated content into structured learning items.

Server receives, as input, the raw text output from the generative AI model. Server analyzes the text using pattern-matching rules or lightweight parsing, detecting segments labeled as questions, answers, hints, and explanations based on markers such as “Question 1:”, “Answer:”, and “Explanation:”. Server performs data processing by splitting the text into separate items, assigning each item a unique identifier, and constructing structured objects that include fields for problem text, solution text, explanation text, and associated difficulty tags. As output, server generates a list of learning items ready for presentation and stores these items in a structured format in main memory or a short-term database table.

### Step 10:

Server delivers learning items to the terminal.

Server receives, as input, the list of structured learning items generated in Step 9 and the current session identifier. Server formats these items into a response message, including metadata such as topic identifier, estimated difficulty, and recommended completion time. Server performs data processing by serializing the structured objects into a data-interchange format, such as JSON, and attaching session and ordering information. As output, server transmits the serialized content package to the terminal over a network connection.

### Step 11:

Terminal presents learning content and collects user interactions.

Terminal receives, as input, the content package from the server containing learning items and metadata. Terminal decodes the serialized data, instantiates user-interface components such as text blocks, input fields, and buttons, and renders questions and explanations on the display. Terminal performs data processing by tracking user actions, including which items are viewed, how long each item remains in focus, which hints are requested, and what answers are entered. As output, terminal generates interaction logs and answer information objects that describe user responses and behavior in association with item identifiers.

### Step 12:

User engages with learning items and submits answers.

User receives, as input, the visual and textual content presented on the terminal display. User reads explanations, considers question statements, and enters answers through input mechanisms such as keyboard, touch, or voice input. User may request hints or navigate between items, generating a sequence of interactions. As output, user provides answer information, hint usage signals, and navigation commands, which the terminal encodes into structured messages for transmission to the server.

### Step 13:

Terminal transmits answer information and operation history to the server.

Terminal receives, as input, answer information and operation history events generated by the user's interactions in Step 12. Terminal batches these events according to defined criteria (e.g., upon completion of each question or after a time threshold), tags them with timestamps and session identifiers, and encodes them in a predefined message schema. Terminal performs data processing by compressing and encrypting the message if necessary, and then sends the message to the server over the network. As output, terminal delivers a progress-report payload containing answer information and operation history information to the server.

### Step 14:

Server evaluates answers and updates comprehension metrics.

Server receives, as input, the progress-report payload from the terminal, including answer information and operation history information. Server retrieves the corresponding learning items from the content cache to access correct answers and difficulty metadata. Server performs data processing by comparing each user answer with the associated correct answer-either by direct string or numeric comparison or by constructing a grading prompt sentence for complex or open-ended responses and sending it to the generative AI model- and determining correctness or partial correctness. Server also computes performance metrics such as time-to-answer, hint usage count, and sequence of attempts. As output, server generates updated comprehension metrics per topic and per problem, stores these metrics in the learning history information, and produces an evaluation result object for the current interaction.

### Step 15:

Server generates a feedback-oriented prompt sentence and obtains feedback content.

Server receives, as input, the evaluation result object from Step 14 and the current emotional state from Step 5. Server composes a feedback policy that depends on correctness and emotion; for example, server may choose a remedial explanation when correctness is low and emotion indicates confusion. Server constructs a feedback-oriented prompt sentence, such as: “The learner answered the following derivative problem incorrectly and appears confused. Provide a clear, step-by-step explanation and one simpler follow-up exercise.” Server performs data processing by passing this prompt sentence to the generative AI model, receiving generated feedback text and optional follow-up questions, and parsing the returned text into structured feedback items. As output, server obtains feedback information and additional learning content tailored to the evaluation and emotion, and stores them for delivery to the terminal.

### Step 16:

Server transmits feedback and additional content to the terminal.

Server receives, as input, the structured feedback items and any additional learning content generated in Step 15. Server packages these items together with identifiers of the original questions and context metadata, encodes them into a response message, and sends the message to the terminal. Server performs data processing by ensuring that each feedback item is correctly associated with its corresponding question and by ordering messages so that the terminal can render them in a coherent sequence. As output, server delivers a feedback package that instructs the terminal on how to present explanations, correctness indicators, and follow-up tasks.

### Step 17:

Terminal displays feedback and updates the user interface.

Terminal receives, as input, the feedback package from the server. Terminal maps feedback items to the original questions displayed earlier, overlays correctness indicators (such as “Correct” or “Incorrect”), and renders explanations and follow-up questions below or next to the corresponding items. Terminal performs data processing by updating internal state for each item (e.g., marking items as completed or pending review) and refreshing visible components on the display. As output, terminal provides the user with visual and interactive feedback, enabling the user to review mistakes, read explanations, and proceed to additional exercises.

### Step 18:

Server updates learning course information and adjusts parameters for future prompt sentences.

Server receives, as input, the latest comprehension metrics, emotional-state records, and completion status of the presented learning items. Server executes a course-update algorithm that evaluates whether the learner should advance to more difficult topics, remain at the current level, or revert to review material. Server performs data processing by computing aggregate performance indices over recent interactions, applying thresholds and decision rules, and updating the learning course information stored in the storage device, including progression order and difficulty level for each upcoming topic. As output, server produces an updated learning course record and modified control parameters (such as target_difficulty and next_target_topic), which will be consumed as inputs when constructing subsequent intermediate representations and prompt sentences in future iterations.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

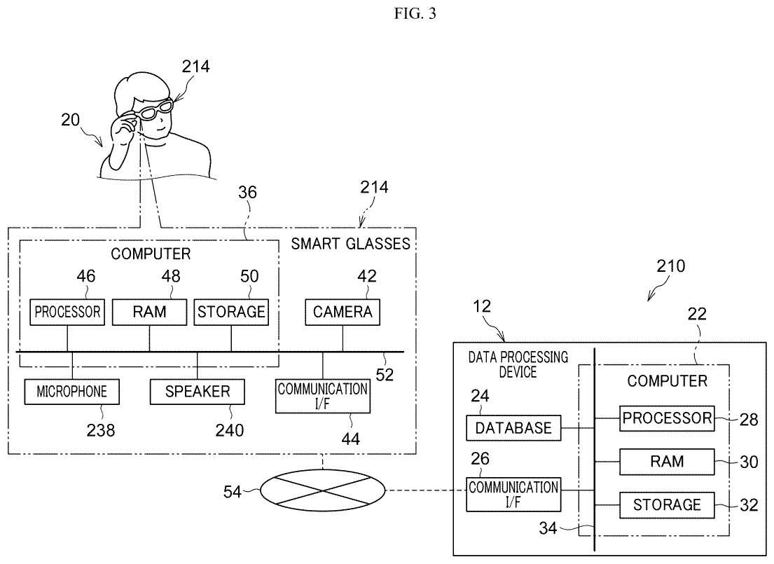

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

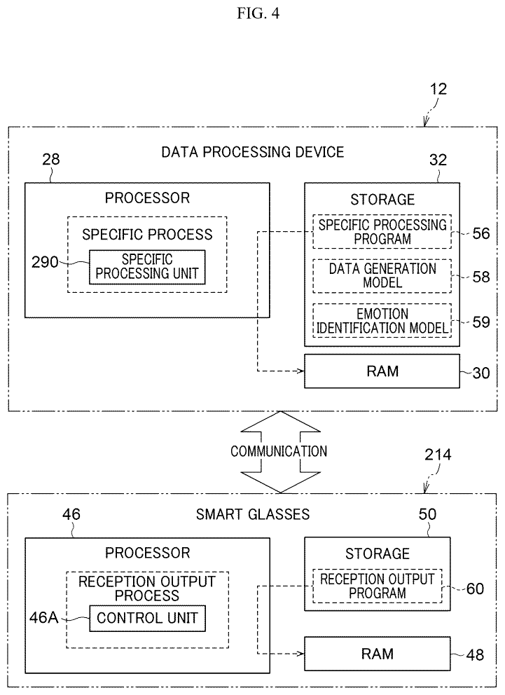

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

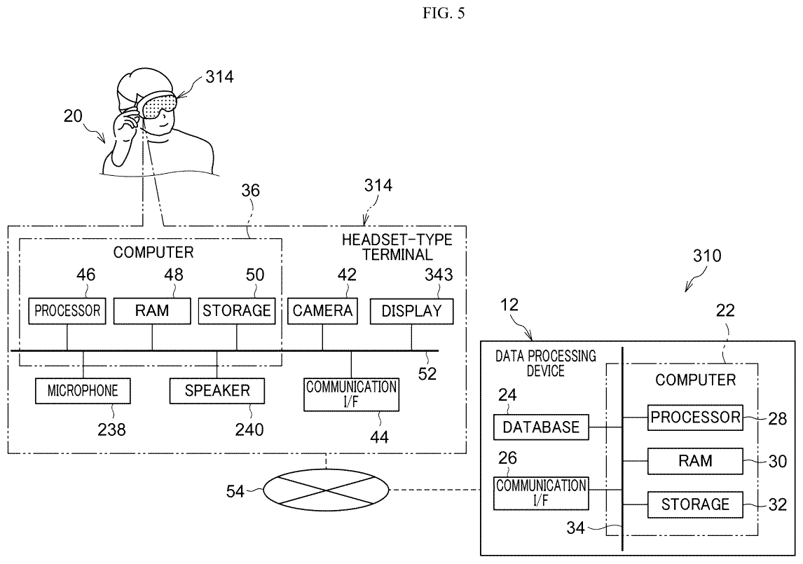

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

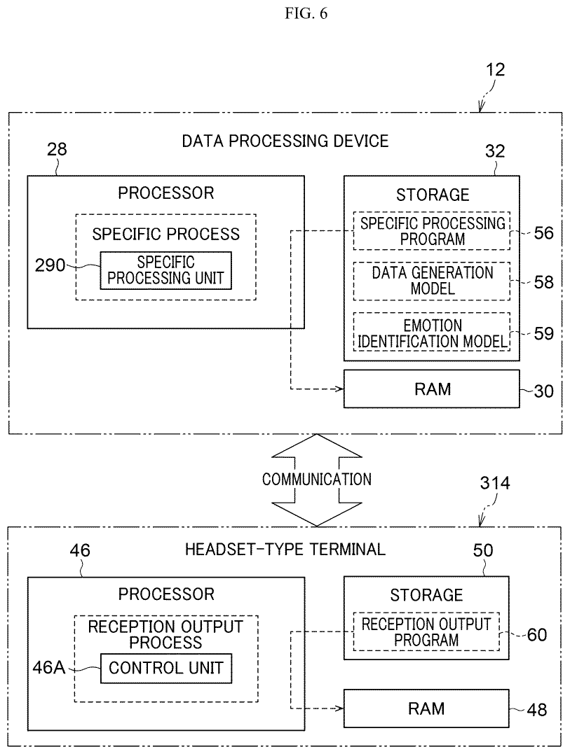

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314.

Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

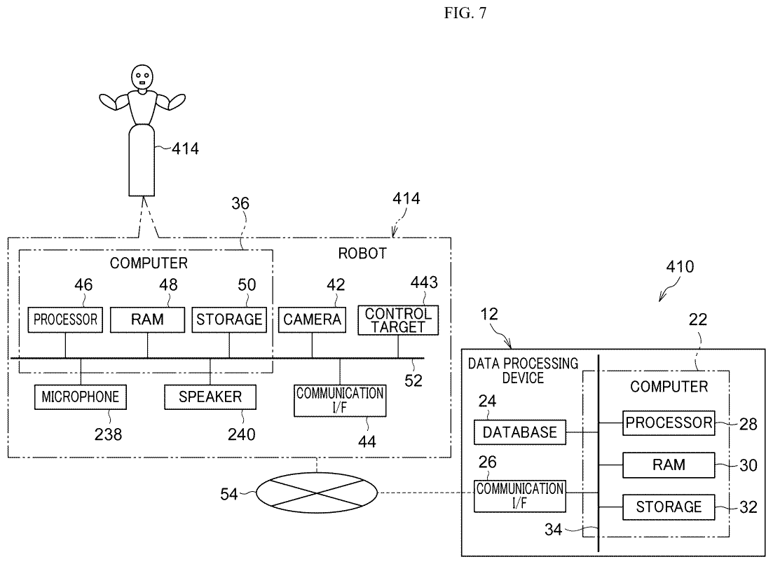

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

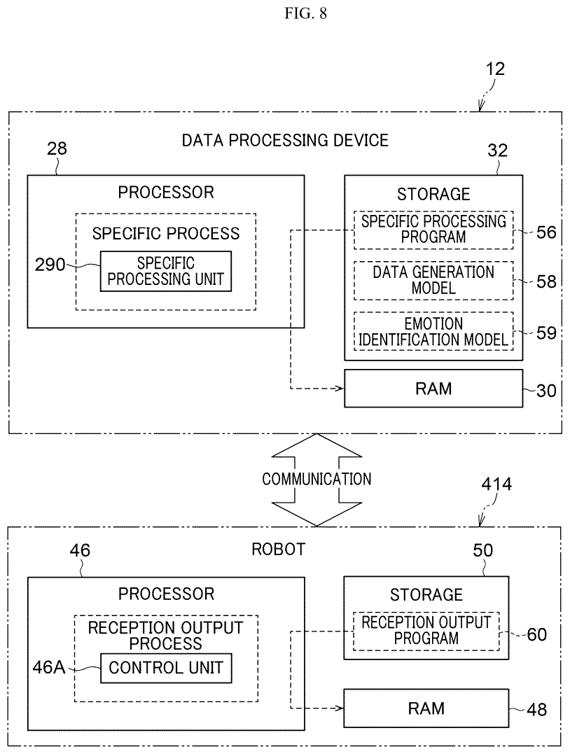

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

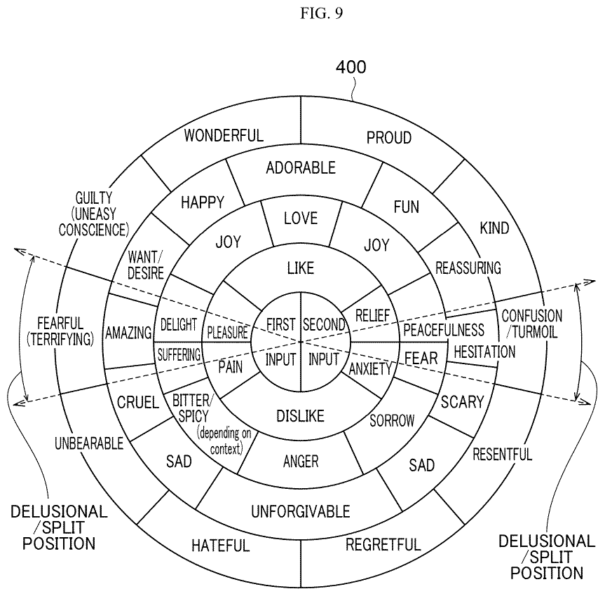

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

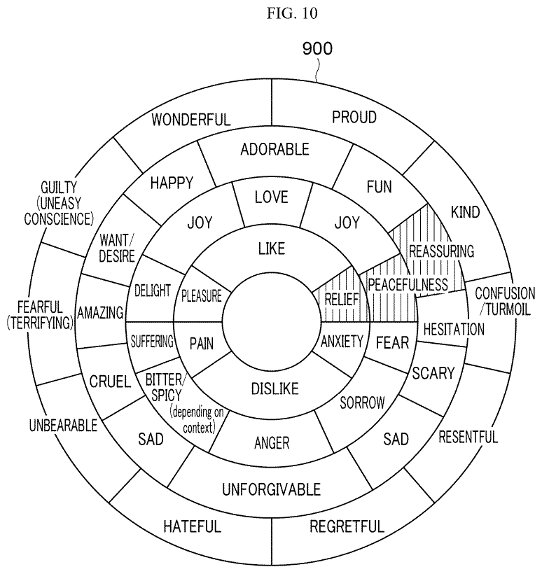

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor and a storage device,
wherein the processor is configured to
receive authentication information including identification information of a learner from an information processing apparatus, compare the authentication information with authentication information stored in the storage device to perform authentication processing of the learner, and
generate session information in response to an authentication result,
identify the learner on the basis of the session information, acquire, from the storage device, past learning history data and test result data associated with the learner, perform preprocessing on the acquired learning history data and test result data including correctness data, time data, and difficulty data to generate feature data, and input the feature data to a learning model using a machine learning algorithm to output an understanding score indicating an understanding level of the learner,
generate a prompt sentence including condition information comprising at least a target field, a target item, a difficulty level, and a question format on the basis of the understanding score, and
input the prompt sentence to a generative AI model to cause the generative AI model to generate question data including problem data, correct answer data, and explanation data in accordance with the understanding score,
transmit the question data to the information processing apparatus so as to cause the information processing apparatus to display a question, receive answer information and answer time information of the learner from the information processing apparatus, and generate determination data indicating correctness and score data by comparing the answer information with the correct answer data,
generate evaluation data including at least the problem data, the correct answer data, the answer information, the determination data, and the understanding score, generate a prompt sentence using the evaluation data, and input the prompt sentence to the generative AI model to cause the generative AI model to generate feedback data including feedback information indicating an error tendency and a misunderstanding of the learner and additional learning question data, transmit the determination data, the score data, and the feedback data to the information processing apparatus so as to display the determination data, the score data, and the feedback data in real time, append the determination data, the score data, the answer time information, and the feedback data as the learning history data to the storage device, and update the understanding score sequentially on the basis of the learning history data, and
change the condition information and contents of the prompt sentence dynamically in accordance with the updated understanding score, and repeatedly instruct the generative AI model to generate subsequent questions adaptively for each learner.

### (Supplementary 2)

The system according to supplementary 1,
wherein the processor is configured to perform clustering processing on understanding scores of a plurality of learners on the basis of the feature data to classify the plurality of learners into a plurality of groups, define group-specific condition information including at least a target field, a target item, and a difficulty level for each of the plurality of groups, and generate, for each of the plurality of groups, a prompt sentence including the group-specific condition information and input the prompt sentence to the generative AI model so that the generative AI model generates group-specific problem data and group-specific feedback data.

### (Supplementary 3)

The system according to supplementary 1,
wherein the processor is configured to detect completion of answering by the learner on the basis of the answer time information, sequentially execute generation processing of the determination data and the score data and generation processing of the prompt sentence using the evaluation data and the feedback data by the generative AI model, and transmit processing results to the information processing apparatus immediately so as to present the feedback information to the learner in real time in response to an operation of the learner.

### Application Example 1

### (Supplementary 1)

A system comprising a processor and a storage device,
wherein the processor is configured to
acquire, from the storage device, past learning history data of a learner, analyze an interest and a tendency of the learner based on the learning history data, and generate a learner profile for the learner,
generate a prompt sentence including a recommendation request content for selecting educational content to be presented to the learner based on the learner profile and attribute information of each educational content included in an educational content set, and an explanation request content for generating explanation information or additional information to be presented to the learner,
input the prompt sentence into a generative AI model and acquire, from the generative AI model, recommendation information of educational content suitable for the learner and explanation information for difficult information included in the educational content,
transmit the recommendation information and the explanation information to a terminal device having a display device, and cause the terminal device to display the recommendation information and the explanation information in association with educational content being viewed or browsed by the learner,
acquire, as behavior history data, a selection operation, a browsing operation, or an evaluation operation performed by the learner with respect to the recommendation information and the explanation information, and update the learner profile based on the behavior history data, specify, as difficult information, a term or an expression having a high possibility of being difficult for the learner based on content information of the educational content and the learner profile, and
generate an explanation prompt sentence including the term or the expression specified as the difficult information and context information around the term or the expression, the explanation prompt sentence instructing generation of explanation information according to a comprehension level and an interest of the learner, and input the explanation prompt sentence into the generative AI model.

### (Supplementary 2)

The system according to supplementary 1,
wherein the processor is configured to
classify the learner into a plurality of learner groups by clustering technology based on the learner profile and the behavior history data, generate, for each learner group, a prompt sentence including recommendation request content and explanation request content that are different among the learner groups, and input the prompt sentence into the generative AI model to acquire recommendation information and explanation information of educational content optimized for each learner group.

### (Supplementary 3)

The system according to supplementary 1,
wherein the processor is configured to
acquire, when the learner is viewing or browsing educational content on the terminal device, playback time information and content identification information transmitted from the terminal device, acquire content information corresponding to a time indicated by the playback time information based on the content identification information, automatically detect difficult information by using the difficult information specified from the content information, and, by inputting into the generative AI model in real time a prompt sentence generated according to the difficult information and the learner profile, generate the explanation information as real-time feedback for the learner and cause the explanation information to be displayed on the terminal device.

### Example 2

### (Supplementary 1)

A system comprising a processor and a storage device,
wherein the processor is configured to
receive learning activity data of a learner from a terminal and store the learning activity data in the storage device as learning history in units of individual learning records, obtain the learning history stored in the storage device, aggregate information included in the learning history including learning targets, learning time, and evaluation results, convert the aggregated information into analysis data representing a learning status of the learner, generate a prompt sentence including the analysis data, and input the prompt sentence to a generative AI model so as to cause the generative AI model to identify learning targets that the learner has understood and learning targets with which the learner is struggling, and
extract a plurality of educational contents from the storage device that stores educational contents based on a comprehension status of the learner identified by the generative AI model, construct a learning course including the extracted educational contents and a learning order, generate a prompt sentence including an explanation of the learning course, progress information of the learning of the learner, and learning targets to be next learned by the learner, input the prompt sentence to the generative AI model so as to cause the generative AI model to generate feedback information including the explanation of the learning course, the progress information, and the learning targets to be next learned, and output the feedback information and the learning course to the terminal.

### (Supplementary 2)

The system according to supplementary 1,
wherein the processor is configured to classify a plurality of learners into a plurality of learner groups by using a statistical method based on the analysis data, generate a prompt sentence including information indicating weak fields and achievement levels common to each learner group, input the prompt sentence to the generative AI model, and cause the generative AI model to generate, for each learner group, a learning course indicating a combination of educational contents suitable for the learner group and a learning order of the educational contents.

### (Supplementary 3)

The system according to supplementary 1,
wherein the processor is configured to evaluate answer data of the learner received from the terminal, generate a prompt sentence including an evaluation result and learning history immediately before the answer, input the prompt sentence to the generative AI model, cause the generative AI model to generate real-time feedback information including a reason for an incorrect answer of the learner, a supplementary explanation, and an educational content to be next presented, and cause the terminal to immediately display the real-time feedback information.

### Application Example 2

### (Supplementary 1)

A system comprising a processor and a storage device,
wherein the processor is configured to
acquire learning history information of a learning subject from the storage device and analyze a comprehension level and weakness areas of the learning subject by using statistical analysis or a machine learning algorithm,
generate a prompt sentence to be input to a generative AI model, the prompt sentence being generated in accordance with conditions including an analysis result of the comprehension level based on the learning history information, an emotional state estimated by using facial information or voice information of the learning subject, and a type and difficulty level of learning content to be output, and input the prompt sentence to the generative AI model so as to cause the generative AI model to generate learning materials or questions to be presented to the learning subject,
evaluate answer information and operation history information of the learning subject received from a terminal device, by determining correctness and required time of the answer information, and input, to the generative AI model, a prompt sentence for instructing generation of feedback information or additional learning content for the learning subject based on an evaluation result and the emotional state, and transmit an output result from the generative AI model to the terminal device, and
generate learning course information in which a progression order and difficulty level of learning topics are dynamically updated for each learning subject based on the evaluation result and the emotional state, and automatically adjust contents of a subsequent prompt sentence in accordance with the learning course information.

### (Supplementary 2)

The system according to supplementary 1,
wherein the processor is configured to perform unsupervised learning processing including clustering on learning history information of a plurality of learning subjects to generate a plurality of learning groups according to comprehension levels and learning tendencies, and to input, to the generative AI model, a prompt sentence including conditions that specify different difficulty levels and question ranges for each learning group so as to cause the generative AI model to collectively generate learning content common to the learning group.

### (Supplementary 3)

The system according to supplementary 1,
wherein the processor is configured to analyze, in real time, facial information and voice information of the learning subject acquired from the terminal device to estimate the emotional state, and, when the emotional state indicates confusion or fatigue, to input to the generative AI model a prompt sentence including conditions for generating review learning content with reduced difficulty, and, when the emotional state indicates excitement or joy, to input to the generative AI model a prompt sentence including conditions for generating advanced learning content with increased difficulty, thereby presenting to the learning subject learning content and feedback information whose difficulty is stepwise adjusted.

What is claimed is:

1. A system comprising:
circuitry configured to:
acquire, via a communication interface coupled to a packet-switched network, interaction record data associated with a user from a storage device, and apply a machine learning algorithm to feature data derived from the interaction record data to compute a proficiency score indicating a comprehension level of the user;
generate a first prompt sentence based on the proficiency score and condition information comprising at least a target field, a difficulty level, and an output format, and input the first prompt sentence to a generative neural network model to cause the generative neural network model to generate structured output data items in accordance with the proficiency score;
transmit, via the communication interface, the structured output data items as a notification data packet to a terminal device, receive response data from the terminal device, and generate determination data by comparing the response data with reference data associated with the structured output data items;
generate evaluation data comprising the structured output data items, the reference data, the response data, the determination data, and the proficiency score, generate a second prompt sentence based on the evaluation data, and input the second prompt sentence to the generative neural network model to cause the generative neural network model to generate evaluation response data indicating an error tendency and supplemental content; and
store the determination data and the evaluation response data in the storage device as updated interaction record data, and update the proficiency score based on the updated interaction record data.

2. The system according to claim 1, wherein the interaction record data comprises correctness data, time data, and difficulty data for each prior interaction, and wherein the feature data is generated by performing preprocessing on the interaction record data including normalization and aggregation of the correctness data, the time data, and the difficulty data.

3. The system according to claim 2, wherein the machine learning algorithm comprises a supervised classification model trained on labeled interaction records, and wherein the proficiency score comprises a multi-dimensional vector indicating comprehension levels across a plurality of target fields.

4. The system according to claim 3, wherein the circuitry is configured to perform clustering processing on proficiency scores of a plurality of users to classify the plurality of users into a plurality of groups, and to generate, for each group, a group-specific prompt sentence including group-specific condition information and input the group-specific prompt sentence to the generative neural network model to generate group-specific structured output data items.

5. The system according to claim 1, wherein the generative neural network model comprises a transformer-based architecture including multiple self-attention layers and feed-forward layers, and wherein the circuitry is configured to control at least one of a temperature parameter or a top-k sampling threshold during generation of the structured output data items.

6. The system according to claim 5, wherein the structured output data items comprise problem data, reference data, and explanation data, and wherein the circuitry is configured to dynamically change the condition information in the first prompt sentence in accordance with the updated proficiency score to generate subsequent structured output data items adaptively.

7. The system according to claim 1, wherein the circuitry is configured to detect completion of a response by the user based on a response time measurement, sequentially execute generation of the determination data and generation of the evaluation response data, and transmit the evaluation response data to the terminal device as a real-time notification data packet.

8. The system according to claim 1, wherein the circuitry is configured to generate a learner profile comprising an interest indicator and a tendency indicator derived from the interaction record data, and to generate the first prompt sentence further based on the learner profile.

9. The system according to claim 8, wherein the circuitry is configured to extract, from content data stored in the storage device, a plurality of content items, construct a progression sequence comprising the plurality of content items and an ordering based on the proficiency score and the learner profile, and transmit the progression sequence to the terminal device.

10. The system according to claim 9, wherein the circuitry is configured to identify, based on the content data and the learner profile, a term or an expression having a high difficulty indicator for the user, generate an explanation prompt sentence including the term or the expression and context information, and input the explanation prompt sentence to the generative neural network model to generate explanation data for the term or the expression.

11. The system according to claim 1, wherein the circuitry is configured to receive, from the terminal device, a selection operation, a browsing operation, or an evaluation operation performed by the user with respect to the evaluation response data, and to update the interaction record data based on the selection operation, the browsing operation, or the evaluation operation.

12. The system according to claim 1, wherein the circuitry is configured to receive authentication information including identification information of the user from the terminal device, compare the authentication information with stored authentication information to perform authentication processing, and generate session information associated with the user.

13. The system according to claim 1, wherein the evaluation response data comprises feedback information indicating the error tendency, a supplementary explanation, and an additional structured output data item to be next presented to the user.

14. The system according to claim 1, wherein the circuitry is configured to receive, from the terminal device, playback time information and content identification information, acquire content data corresponding to the playback time information, and generate an explanation prompt sentence in real time based on the content data and the proficiency score.

15. The system according to claim 1, wherein the circuitry is configured to estimate an emotional state of the user based on at least one of facial image data captured by an image sensor of the terminal device or voice waveform data captured by a microphone of the terminal device, and to adjust the condition information in the first prompt sentence based on the estimated emotional state.

16. The system according to claim 15, wherein the circuitry is configured to, when the estimated emotional state indicates confusion or fatigue, generate a prompt sentence including conditions for generating structured output data items with reduced difficulty, and when the estimated emotional state indicates engagement, generate a prompt sentence including conditions for generating structured output data items with increased difficulty.

17. The system according to claim 1, wherein the circuitry is configured to input the determination data and the updated proficiency score to the generative neural network model as an additional prompt, and cause the generative neural network model to generate a progress summary comprising identified strengths and areas requiring additional interaction.

18. A system comprising:
circuitry configured to:
acquire, via a communication interface coupled to a packet-switched network, interaction record data associated with a user from a storage device, perform preprocessing on the interaction record data including normalization of correctness data, time data, and difficulty data to generate feature data, and input the feature data to a machine learning model comprising a supervised classification algorithm to compute a proficiency score;
perform clustering processing on proficiency scores of a plurality of users to classify the plurality of users into a plurality of groups, and generate, for each group, a group-specific prompt sentence including condition information comprising a target field, a difficulty level, and an output format;
input each group-specific prompt sentence to a generative neural network model comprising a transformer-based architecture to generate group-specific structured output data items, transmit the group-specific structured output data items to a terminal device associated with each user, and receive response data from the terminal device;
generate determination data by comparing the response data with reference data, generate evaluation data comprising the determination data and the proficiency score, input a second prompt sentence based on the evaluation data to the generative neural network model to generate evaluation response data, and transmit the evaluation response data as a notification data packet to the terminal device; and
estimate an emotional state of the user based on at least one of facial image data or voice waveform data received from the terminal device, and adjust the condition information in subsequent prompt sentences based on the estimated emotional state and the updated proficiency score.

19. The system according to claim 18, wherein the circuitry is configured to extract, based on content data and a learner profile derived from the interaction record data, a term having a high difficulty indicator for the user, generate an explanation prompt sentence including the term and context information, and input the explanation prompt sentence to the generative neural network model to generate explanation data for real-time presentation on the terminal device.

20. A method comprising:
acquiring, via a communication interface coupled to a packet-switched network, interaction record data associated with a user from a storage device, and applying a machine learning algorithm to feature data derived from the interaction record data to compute a proficiency score indicating a comprehension level of the user;
generating a first prompt sentence based on the proficiency score and condition information comprising at least a target field, a difficulty level, and an output format, and inputting the first prompt sentence to a generative neural network model to cause the generative neural network model to generate structured output data items in accordance with the proficiency score;
transmitting, via the communication interface, the structured output data items as a notification data packet to a terminal device, receiving response data from the terminal device, and generating determination data by comparing the response data with reference data associated with the structured output data items;
generating evaluation data comprising the structured output data items, the reference data, the response data, the determination data, and the proficiency score, generating a second prompt sentence based on the evaluation data, and inputting the second prompt sentence to the generative neural network model to cause the generative neural network model to generate evaluation response data indicating an error tendency and supplemental content; and
storing the determination data and the evaluation response data in the storage device as updated interaction record data, and updating the proficiency score based on the updated interaction record data.
